(19) United States
(12) Patent Application Publication
(10) Pub. No.: US 2017/0223112 A1
(43) Pub. Date: Aug. 3, 2017

(54) COMMUNICATION SYSTEM, COMMUNICATION RELAY DEVICE, AND RECORDING MEDIUM

(71) Applicant: KONICA MINOLTA, INC., Tokyo (JP)

(72) Inventor: Takahiro KOUNO, Kawanishi-shi (JP)

(73) Assignee: KONICA MINOLTA, INC., Tokyo (JP)

(21) Appl. No.: 15/412,098

(22) Filed: Jan. 23, 2017

(30) Foreign Application Priority Data
Jan. 29, 2016 (JP) 2016-016135

(51) Int. Cl. H04L 29/08

(52) U.S. Cl. CPC H04L 67/141; H04L 67/28; H04L 67/10

(57) ABSTRACT

A communication system includes at least one device, at least one cloud server, and a communication relay device that relays communication between the at least one device and at least one application executed by the at least one cloud server. The communication relay device receives a connection request to establish an individual connection between the communication relay device and one of the at least one application. The communication relay device determines an application-specific upper-limit number and establishes a new individual connection with the application, on condition that the total number of individual connections currently established between the communication relay device and the application is less than the application-specific upper-limit number for the application. In the presence of a high-load application, the communication relay device increases the time interval of requests for communication between the high-load application and the communication relay device.

This application is based on Japanese Patent Application No. 2016-016135 filed on Jan. 29, 2016, the contents of which are hereby incorporated by reference.

### BACKGROUND OF INVENTION

Technical Field

The present invention relates to a communication system for carrying out communication between cloud servers outside firewalls and devices inside the firewalls, and to a technique related thereto.

Background Art

There are techniques for interfacing between servers (e.g., cloud servers) outside LANs and devices (e.g., image forming apparatuses) inside the LANs.

One example is a technique for printing out electronic documents stored in servers (cloud servers) in clouds by using image forming apparatuses (e.g., Multi-Functional Peripherals; MFPs) in local area networks (LANs) (see Japanese Patent Application Laid-Open No. 2013-73578).

Japanese Patent Application Laid-Open No. 2013-73578 discloses a document output system (communication system) that includes image forming apparatuses (devices), a gateway, and a cloud server. In this system, an electronic document stored in the cloud server is transmitted via the gateway to an image forming apparatus and printed out by the image forming apparatus. The gateway and the image forming apparatuses (devices) are provided inside a LAN, and the cloud server is provided outside the LAN.

The communication system as described above uses individually established communication connections, i.e., individual connections, for communication between the multiple devices (e.g., MFPs) and applications (programs) installed in the cloud server, in order to ensure confidentiality, for example. The individual connections may be tunnel connections using HTTP (more specifically, HTTPS).

In the communication system, a short-term and rapid communication traffic increase (i.e., sudden load increase) may occur in some cases, such as where the timing of a processing request overlaps with the timing of other processing requests.

Problems such as a steady load increase (e.g., load increase due to increasing number of users and increasing number of image forming apparatuses such as MFPs) can be handled by grasping information such as the number of users and the number of image forming apparatuses in advance and increasing the hardware capability of the communication system.

However, besides the steady load increase, a sudden load increase as mentioned above can also occur in the communication system. It is difficult to improve the hardware capability of the system in real time to cope with such a sudden load increase. In particular, real-time improvement of the hardware capability of devices installed in places such as customer companies (e.g., on-premises devices such as gateways) is extremely difficult.

Thus, if the load of communication between an application (specific application) installed in a cloud server and a gateway increases suddenly, a relatively large load will be applied on the gateway in the communication system, and processing of the gateway will delay due to the relatively large load. As a result, users of applications other than the specific application will also be adversely affected.

### SUMMARY OF INVENTION

It is an object of the present invention to provide a technique with which even if application use is suddenly concentrated on a specific application, adverse effects thereof on users of other applications will be avoided or suppressed.

According to a first aspect of the present invention, a communication system includes at least one device provided inside a firewall, at least one cloud server provided outside the firewall, and a communication relay device configured to relay communication between the at least one device and at least one application that is executed by the at least one cloud server. The communication relay device includes a communication control unit configured to receive a connection request that is based on a communication request received from one of the at least one device or one of the at least one application and that is a request to establish an individual connection between the communication relay device and one application among the at least one application, and a determination unit configured to determine an application-specific upper-limit number on the basis of circumstances of establishment of individual connection between the communication relay device and the at least one application, the application-specific upper-limit number being an upper-limit number for each application and being an upper-limit number of individual connections that can be established between the communication relay device and the at least one application. The communication control unit is configured to establish a new individual connection with the one application in accordance with the connection request, on condition that a total number of individual connections currently established between the communication relay device and the one application is less than the application-specific upper-limit number for the one application, and in the presence of a high-load application, increase a time interval of requests for communication between the high-load application and the communication relay device, the high-load application being an application whose total number of individual connections currently established with the communication relay device exceeds the application-specific upper-limit number.

According to a second aspect of the present invention, a communication relay device for relaying communication between at least one device provided inside a firewall and at least one application that is executed by at least one cloud server provided outside the firewall includes a communication control unit configured to receive a connection request that is based on a communication request received from one of the at least one device or one of the at least one application and that is a request to establish an individual connection between the communication relay device and one application among the at least one application, and a determination unit configured to determine an application-specific upper-limit number on the basis of circumstances of establishment of individual connection between the communication relay device and the at least one application, the application-specific upper-limit number being an upper-limit number for each application and being an upper-limit number of individual connections that can be established between the communication relay device and the at least one application. The communication control unit is configured to establish a new individual connection with the one application in response to the connection request, on condition that a total number of individual connections currently established between the communication relay device and the one application is less than the application-specific upper-limit number for the one application, and in the presence of a high-load application, increase a time interval of requests for communication between the high-load application and the communication relay device, the high-load application being an application whose total number of individual connections currently established with the communication relay device exceeds the application-specific upper-limit number.

According to a third aspect of the present invention, a non-transitory computer-readable recording medium has stored therein a program that causes a computer that is built into a communication relay device for relaying communication between at least one device provided inside a firewall and at least one application that is executed by at least one cloud server provided outside the firewall, to execute the steps of a) receiving a connection request that is based on a communication request received from one of the at least one device or one of the at least one application and that is a request to establish an individual connection between the communication relay device and one application among the at least one application, b) determining an application-specific upper-limit number on the basis of circumstances of establishment of individual connection between the communication relay device and the at least one application, the application-specific upper-limit number being an upper-limit number for each application and being an upper-limit number of individual connections that can be established between the communication relay device and the at least one application, c) establishing a new individual connection with the one application in response to the connection request, on condition that a total number of individual connections currently established between the communication relay device and the one application is less than the application-specific upper-limit number for the one application, and d) in the presence of a high-load application, increasing a time interval of requests for communication between the high-load application and the communication relay device, the high-load application being an application whose total number of individual connections currently established with the communication relay device exceeds the application-specific upper-limit number.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 illustrates a schematic configuration of a communication system.

FIG. 2 illustrates part of FIG. 1.

FIG. 3 is a schematic diagram illustrating a configuration of an MFP (device).

FIG. 4 illustrates schematic configurations of constituent elements.

FIG. 5 is a conceptual diagram illustrating tunnel communication.

FIG. 6 is a conceptual diagram illustrating tunnel communication.

FIG. 7 illustrates operations relating to an “application-triggered communication request.”

FIG. 8 illustrates operations relating to a “device-triggered communication request.”

FIG. 9 is a flowchart of operations performed by a management server.

FIG. 10 is a flowchart of operations performed by a gateway.

FIG. 11 is a flowchart of operations performed by the gateway.

FIG. 12 illustrates part of information (information about a load condition of each gateway 30; standby-state information) stored in the management server.

FIG. 13 illustrates an upper-limit number setting table.

FIG. 14 is a flowchart of operations performed by a gateway according to a second embodiment.

FIG. 15 illustrates an upper-limit number setting table.

FIG. 16 illustrates a connection history of tunnel connections between a gateway and each application.

FIG. 17 illustrates the results of summarization obtained from the connection history.

FIG. 18 illustrates (a variation of) operations relating to a “device-triggered communication request.”

### DETAILED DESCRIPTION OF PREFERRED EMBODIMENTS

Hereinafter, embodiments of the present invention will be described with reference to drawings.

### 1. First Embodiment

1-1. Overview of System Configuration

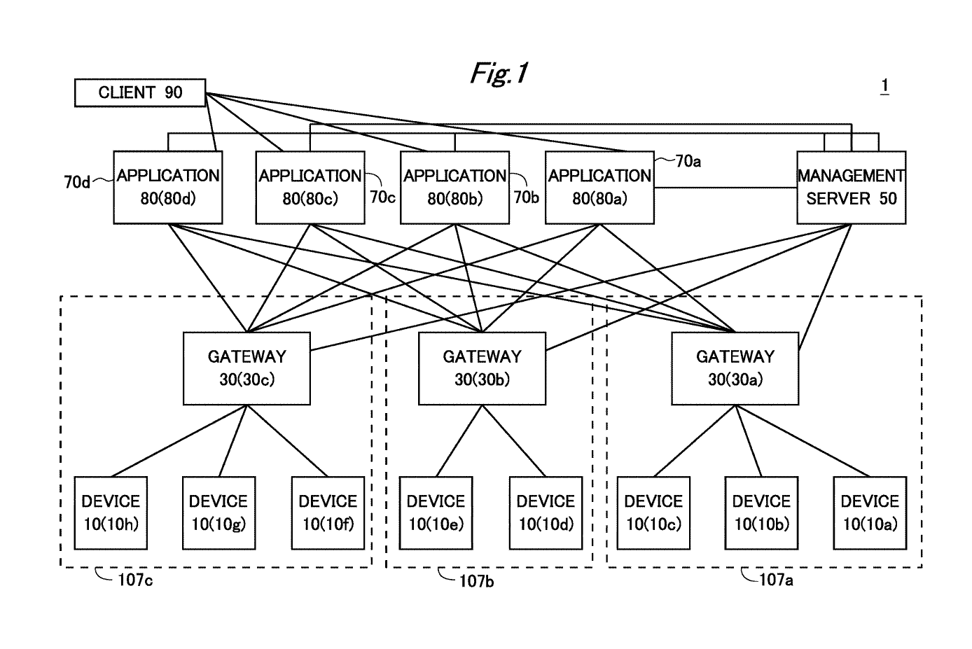

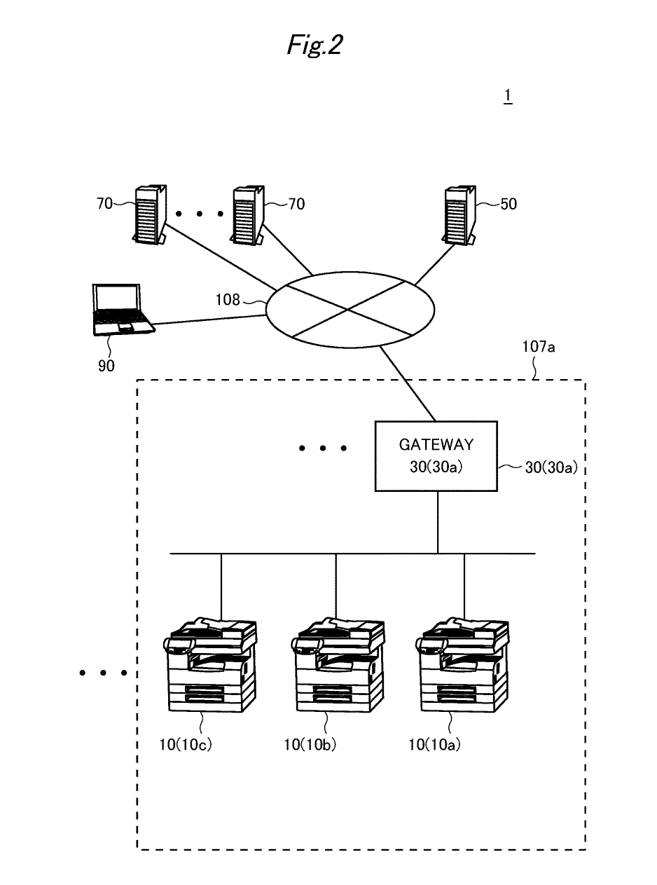

FIGS. 1 and 2 illustrate a schematic configuration of a communication system 1 according to an embodiment of the present invention. FIG. 2 illustrates part of FIG. 1.

As illustrated in FIGS. 1 and 2, the communication system 1 includes multiple devices 10 (10a, 10b, 10c, and so on), multiple gateways 30 (30a, 30b, and so on), and a management server computer (hereinafter, also simply referred to as a “management server”) 50. The communication system 1 further includes multiple cloud server computers (hereinafter, also simply referred to as “cloud servers”) 70 and multiple client computers (hereinafter, also simply referred to as “clients”) 90.

These constituent elements 10, 30, 50, 70, and 90 are connected to one another via a network 108 (see FIG. 2) and can carry out network communication. The network 108 may be configured by local area networks (LANs) 107 and the Internet. A form of connection to the network 108 may be a wired connection or a wireless connection.

Each gateway 30 and one or more devices 10 that correspond to the gateway 30 are provided inside each LAN 107 (in other words, inside a firewall) installed in, for example, a company. Each gateway 30 is connected to devices 10 that are provided inside the same LAN 107. To be more specific, for example, one gateway 30a and three devices 10 (10a, 10b, and 10c) are provided inside a LAN 107a of a company, and one gateway 30b and two devices 10 (10d and 10e) are provided inside a LAN 107b of another company, as illustrated in FIG. 1. Each LAN 107 may include one gateway 30, or may include two or more gateways 30.

On the other hand, the management server 50, the cloud servers 70, and the clients 90 are provided outside the LANs 107 (in other words, outside the firewalls). Note that the clients 90 may be provided inside the LANs 107.

Here, Multi-Functional Peripherals (also referred to as “MFPs” in abbreviated form) are shown as an example of the devices 10. The MFPs may also be referred to as “image forming apparatuses,” “image processing apparatuses,” or “communication devices.”

The gateways 30, the management server 50, the cloud servers 70, and the clients 90 may be configured using, for example, a server computer or a personal computer.

The communication system 1 performs processing on the basis of a communication request received from a cloud server 70 (to be more specific, an application software program (hereinafter, also simply referred to as “application”) 80 installed in the cloud server 70). The communication request from the application 80 is issued from that application 80 (i.e., the application serves as a trigger) and is thus also referred to as an “application-triggered communication request.” The “application-triggered communication request” is a communication request (data transmission request) that is issued in a direction from the top side (cloud server 70 side) to the bottom side (device 10 side) in FIG. 1 (which is also referred to as a “downward direction”). For example, a print instruction (and print data) transmitted from a client 90 to a cloud server 70 is transmitted via the management server 50 and a gateway 30 to a device (MFP) 10 and printed out by the device 10. This printout processing is performed via the cloud server and is thus also referred to as “cloud printing,” for example. Such a communication request that relates to print data transmission in “cloud printing” is one example of the “application-triggered communication request.”

The communication system 1 also performs processing on the basis of a communication request received from a device 10 (via a gateway). The communication request from the device 10 is issued from the device 10 (i.e., the device serves as a trigger) and is thus also referred to as a “device-triggered communication request.” The “device-triggered communication request” is a request to perform processing opposite to the aforementioned “downward” processing, i.e., a communication request that is issued in a direction from the bottom side (device 10 side) to the top side (cloud server 70 side) in FIG. 1 (which is also referred to as an “upward direction”). For example, a scanned image generated by a device 10 is transmitted from the device 10 via a gateway 30 to a cloud server 70 and stored in the cloud server 70 under the control of the management server 50. Such scan processing involves processing for storing data in a cloud server and is thus also referred to as “cloud scanning,” for example. Such a communication request that relates to data storage in “cloud scanning” is one example of the “device-triggered communication request.”

Each cloud server 70 has installed therein one or more applications 80. Each application 80 is provided in Software as a Service (SaaS) mode. In other words, the function of each application 80 is provided in the form of a service. For example, an application 80a for cloud printing is installed into a cloud server 70a so that a cloud printing service is provided by using, for example, the application 80a and a device 10. Also, an application 80b for cloud scanning is installed into a cloud server 70b so that a cloud scanning service is provided by using, for example, the application 80b and a device 10.

Each gateway 30 has a function of relaying communication between devices 10 that correspond to the gateway 30 and multiple cloud servers 70 (to be more specific, applications 80). Each gateway 30 is thus also referred to as a “communication relay device.”

The communication system 1 uses individually established communication connections, i.e., individual connections, for communication between each device 10 (e.g., MFP) and each application 80 installed in the cloud servers 70, in order to ensure confidentiality, for example. The individual connections may be tunnel connections using HTTP (to be more specific, HTTPS).

The management server 50 is a device that manages, for example, communication between the multiple devices 10 and the multiple cloud servers 70 (to be more specific, applications 80), and in particular, communication (tunnel connection communication) via the gateways 30.

For example, the management server 50 receives a request (communication request) to access a specific device 10 among the multiple devices 10 from a cloud server 70 (application 80), and in response to the access request, transmits a tunnel connection request to establish a tunnel connection with the cloud server 70, to the gateway 30 that corresponds to the specific device 10 among the multiple gateways 30.

Here, each tunnel connection request is a request that requires one of the multiple gateways 30 to carry out communication using a tunnel connection between the gateway 30 and one of the multiple cloud servers 70 (multiple applications 80).

1-2. Overview of MFP Configuration

Next is a description of the devices 10.

As described above, the present embodiment shows Multi-Functional Peripherals (also referred to as “MFPs” in abbreviated form) as an example of the devices 10.

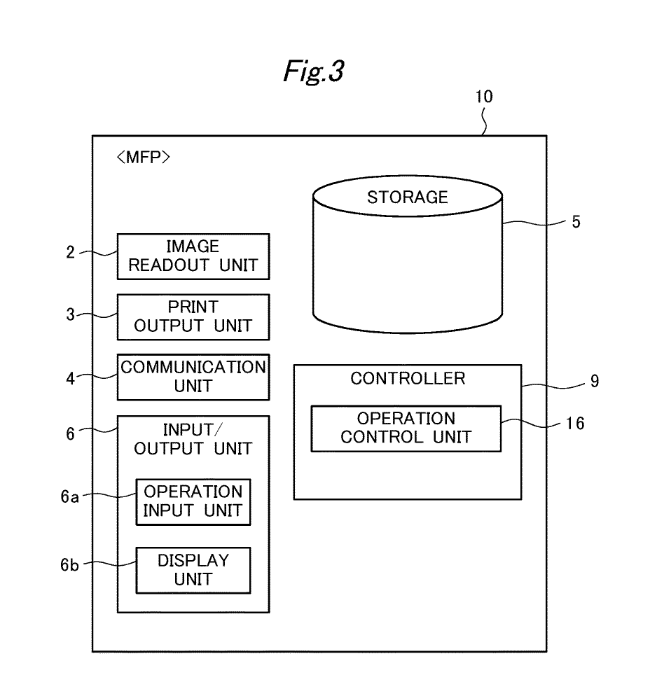

FIG. 3 is a schematic diagram illustrating a configuration of an MFP. The MFP is a device (also referred to as “Multi-Functional Peripheral”) that has functions such as a scanner function, a printer function, a copy function, and a data communication function.

The MFP may be an image forming apparatus that can perform processing such as printout processing (printing) and image reading processing (scanning).

As illustrated in FIG. 3, the MFP includes an image reading unit 2, a print output unit 3, a communication unit 4, a storage 5, an input/output unit 6, and a controller 9 and implements various types of functions by operating these constituent elements in combination.

The image reading unit 2 is a processing unit that optically reads an original document placed at a predetermined position on the MFP and generates image data (also referred to as an “original image”) of the original document.

The print output unit 3 is an output unit that prints out an image to various types of medium, such as paper, on the basis of image data about a target image.

The communication unit 4 is a processing unit capable of facsimile communication via, for example, a public network. The communication unit 4 is also capable of network communication via the network 108. This network communication uses various types of communication protocols such as a User Datagram Protocol (UDP), a Transmission Control Protocol (TCP), an Internet Protocol (IP), a Simple Network Management Protocol (SNMP), and a File transfer Protocol (FTP). Using the network communication allows the MFP to exchange various types of data with desired devices (e.g., gateways 30, management server 50, and cloud servers 70).

For example, the communication unit 4 of the MFP can communicate with a cloud server 70 via a gateway 30 (i.e., transmit data to the cloud server 70 and/or receive data from the cloud server 70) by using a tunnel connection (described later) established between the gateway 30 and the cloud server 70. The communication unit 4 includes a transmitter that transmits data or other information to other devices, and a receiver that receives data or other information from other devices.

The storage 5 is configured by storage devices such as a hard disk drive (HDD) and nonvolatile memories.

The input/output unit 6 includes an operation input unit 6a that receives input to the MFP, and a display unit 6b that displays and outputs various types of information. The input/output unit 6 is also referred to as an operation unit.

The controller 9 is a control unit that performs overall control of the MFP and includes a CPU and various types of semiconductor memories (e.g., RAM and ROM).

The controller 9 implements various types of processing units (e.g., an operation control unit 16 that controls operations such as image forming) by the CPU executing predetermined software programs (also simply referred to as “programs”) stored in the ROM (e.g., EEPROM (registered trademark)). Note that the programs may be recorded in one of various types of portable recording media such as a USB memory (or in other words, various types of non-transitory computer-readable recording media) and installed via the recording medium into the MFP. Alternatively, the programs may be downloaded via a network or other means and installed into the MFP.

1-3. Overview of Configurations of Constituent Elements

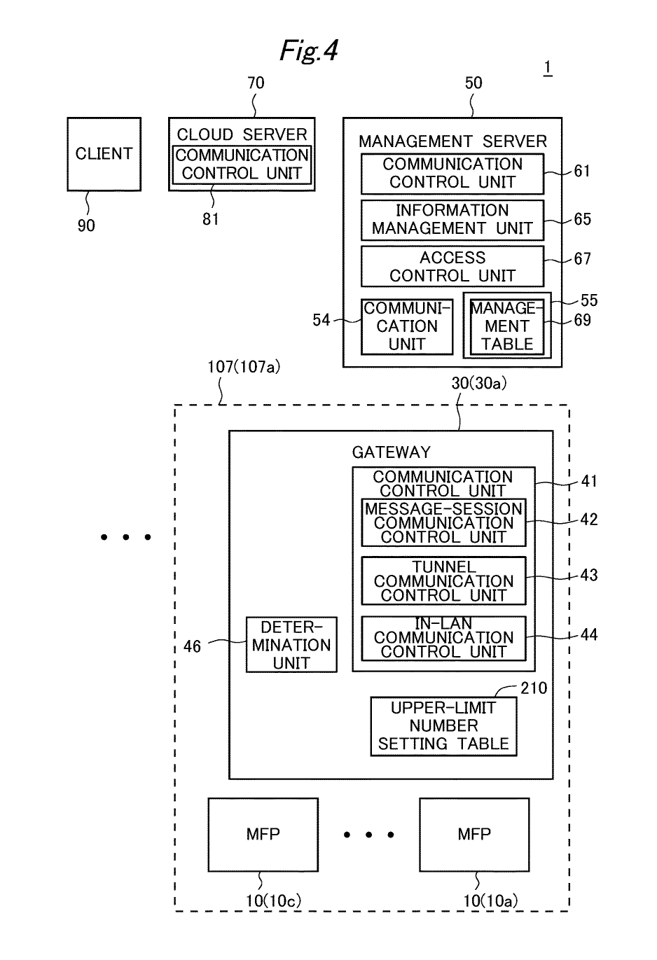

FIG. 4 illustrates schematic configurations of constituent elements such as 30, 50, and 70. These constituent elements will now be described with reference to FIG. 4. In the present embodiment, the gateways 30, the management server 50, the cloud servers 70, and the clients 90 may be constructed by, for example, server computers or personal computers.

Cloud Server 70

Each cloud server 70 includes a communication control unit 81. The communication control unit 81 carries out communication with the management server 50. The communication control unit 81 also carries out communication with each gateway 30 by using tunnel communication, which will be described later.

As described above, each cloud server 70 has installed therein one or more applications 80. Each application 80 communicates with other devices such as 50, 30, and 10 (to be more specific, applications installed in these devices) via, for example, the communication control unit 81.

Gateway 30

Each gateway 30 is a communication relay device that relays communication between each device 10 under the control of the gateway 30 and each cloud server 70 (application 80).

Each gateway 30 includes various processing units such as a communication control unit 41 and a determination unit 46. These various processing units are implemented by the CPU of the gateway 30 executing predetermined programs.

The communication control unit 41 is a processing unit that controls communication with other devices. The communication control unit 41 includes a message-session communication control unit 42, a tunnel communication control unit 43, and an in-LAN communication control unit 44.

The in-LAN communication control unit 44 is a processing unit that carries out communication with various devices in the LAN.

On the other hand, the message-session communication control unit 42 and the tunnel communication control unit 43 are processing units that carry out communication with various devices outside the LAN.

The message-session communication control unit 42 is a processing unit that carries out communication with the management server 50 by using a message session. The message-session communication control unit 42 establishes a message session (e.g., extensible messaging and presence protocol; XMPP) with the management server 50 and carries out communication with the management server 50. The message-session communication control unit 42 is also referred to as a “communication unit for management server” (or a “management-server communication unit”).

The tunnel communication control unit 43 is a processing unit that carries out communication with the cloud servers 70 by using tunnel communication. The tunnel communication control unit 43 establishes a tunnel connection (e.g., a communication session using, for example, a hypertext transfer protocol (HTTP), and more specifically, a hypertext transfer protocol secure (HTTPS)) with a cloud server 70 and relays communication between the cloud server 70 and a specific device 10. The tunnel communication control unit 43 is also referred to as a “communication unit for cloud server” (or a “cloud-server communication unit”).

As will be described later, the use of connections such as tunnel connections will help transmit data from devices (cloud servers 70) outside a LAN 107 to devices (gateway 30 and devices 10) inside the LAN 107, and vice versa.

The determination unit 46 is a processing unit that determines an upper-limit number of individual connections that can be established between the gateway 30 and each application 80, i.e., an upper-limit number for each application (application-specific upper-limit number M, which will be described later). The application-specific upper-limit number M is determined on the basis of the circumstances of establishment of individual connection between the gateway 30 and each application 80.

Management Server 50

The management server 50 is a server that manages the devices 10, the gateways 30, and the cloud servers 70 (including the applications 80).

The management server 50 includes various processing units such as a communication control unit 61, an information management unit 65, and an access control unit 67.

These various processing units are implemented by the CPU of the management server 50 executing predetermined software programs (also simply referred to as “programs”) stored in a storage (e.g., HDD). Note that the programs may be recorded in one of various types of portable recording medium such as a DVD-ROM (in other words, various types of non-transitory computer-readable recording media) and installed via the recording medium into the management server 50. Alternatively, the programs may be downloaded via the network 108 or other means and installed into the management server 50.

The communication control unit 61 controls various communication operations in cooperation with a communication unit 54 (communication hardware). For example, the communication control unit 61 carries out communication with a cloud server 70 and receives an access request from the cloud server 70. The communication control unit 61 also carries out communication with each gateway 30 by using, for example, a message session. The communication unit 54 includes a transmitter that transmits data or other information to other devices, and a receiver that receives data or other information from other devices. The receiver receives multiple communication requests, which will be described later, and the transmitter transmits tunnel connection requests that are based on these multiple communication requests, to gateways 30.

The information management unit 65 is a processing unit that manages, for example, information about the multiple gateways 30 that are managed by the management server 50 (management gateway information), and management device information that is received from each of the multiple gateways 30 (information about devices 10 under the control of each gateway 30). These pieces of information (management gateway information and management device information) are listed in a management table 69 stored in a storage (e.g., HDD) 55 of the management server 50. The management table 69 lists, for example, the management gateway information (i.e., identification information about each gateway 30, such as an IP address) and the management device information that indicates the relationship between each gateway 30 and the devices under the control of the gateway 30 (devices to be managed).

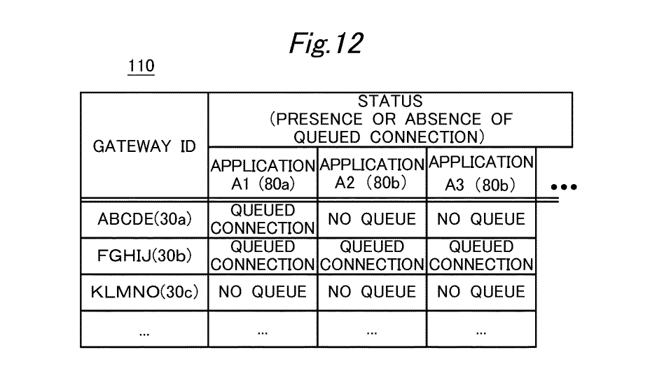

The information management unit 65 also manages information about the multiple cloud servers 70, information about each application 80 in the multiple cloud servers 70, and other information. These pieces of information are also stored in the management table 69. The information management unit 65 also manages information such as the number of tunnel connections established between each gateway 30 and each cloud server 70 by using, for example, the management table 69. The information management unit 65 also acquires information (see standby-state information 110 in FIG. 12) about the current load condition of each gateway 30 (e.g., current connection standby state of each gateway 30; standby state for connection requests based on received communication requests) from each gateway 30 and manages the acquired information.

The access control unit 67 controls, for example, connection requests that are based on communication requests received from the applications 80 (cloud servers 70) on the basis of the standby-state information 110 (FIG. 12). For example, the access control unit 67 determines whether to immediately transmit a connection request that is based on a communication request received from an application 80 (cloud server 70) to a gateway 30 that corresponds to this connection request.

The communication control unit 61 and the communication unit 54, for example, transmit a “tunnel connection request” (a request to establish a tunnel connection between a gateway 30 (communication relay device) and a designated cloud server 70) to the gateway 30.

One example of the tunnel connection request is a connection request that is based on a communication request received from at least one of the applications 80 (e.g., connection request transmitted via the management server 50 to a gateway 30).

Another example of the tunnel connection request is a connection request that is based on a communication request received from at least one of the devices 10. In the present embodiment, a communication request received from at least one of the devices 10 is transmitted directly from the device 10 to a gateway 30 as will be described below.

These tunnel connection requests are also referred to as connection requests to establish individual connection between the gateway 30 and at least one of the applications 80.

Note that the gateway 30 (communication relay device) that has received such a tunnel connection request from the access control unit 67 of the management server 50 establishes a tunnel connection with the cloud server 70 in accordance with the tunnel connection request. The gateway 30 then uses the tunnel connection to relay communication between the cloud server 70 and the connection destination device 10.

1-4. Operations Based on Communication Request

The communication system 1 uses the gateways 30 and the management server 50 for communication between the devices 10 and the cloud servers 70 (applications 80) over the firewalls. More specifically, the communication system 1 performs the following two types of operations, namely, operations that relate to “application-triggered communication requests” and operations that relate to “device-triggered communication requests,” which will be described later.

The following describes the operations relating to an “application-triggered communication request.”

Operations Relating to Application-Triggered Communication Request (“Downward” Operations)

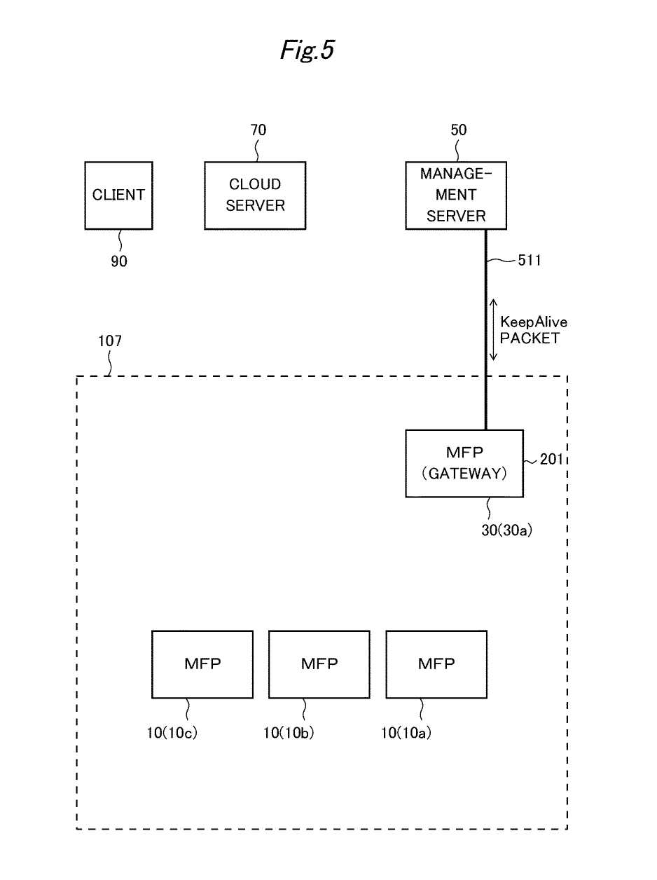

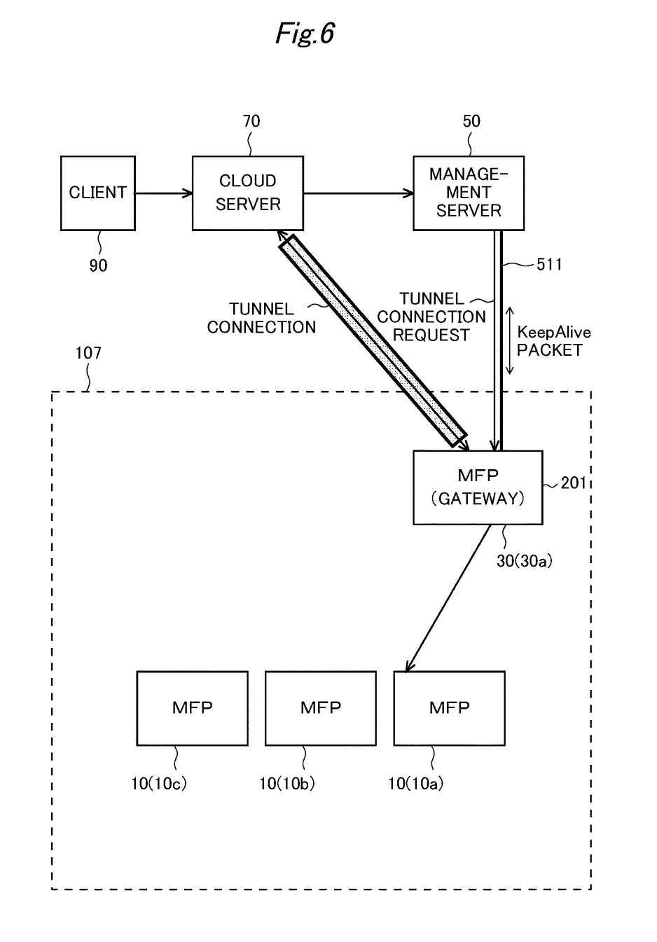

FIGS. 5 and 6 are conceptual diagrams illustrating tunnel communication.

In the present embodiment, tunnel communication is used for the operations as illustrated in FIGS. 5 and 6 (operations relating to an “application-triggered communication request”).

More specifically, firstly, a message session 511 (see FIG. 5) is established (as an exception to the firewall) between the management server 50 outside a LAN and a gateway 30 (30a) inside the LAN, and this message session 511 is used to transmit a tunnel connection request (request to access the device 10a) from the management server 50 to the gateway 30. In response to the tunnel connection request, a tunnel connection is established between the gateway 30 and a cloud server 70 (see FIG. 6). The established tunnel connection is used to gain access from the cloud server 70 outside the LAN to devices 10 inside the LAN via the gateway 30. For example, the device 10a (image forming apparatus) may perform “cloud printing” using the cloud server 70a.

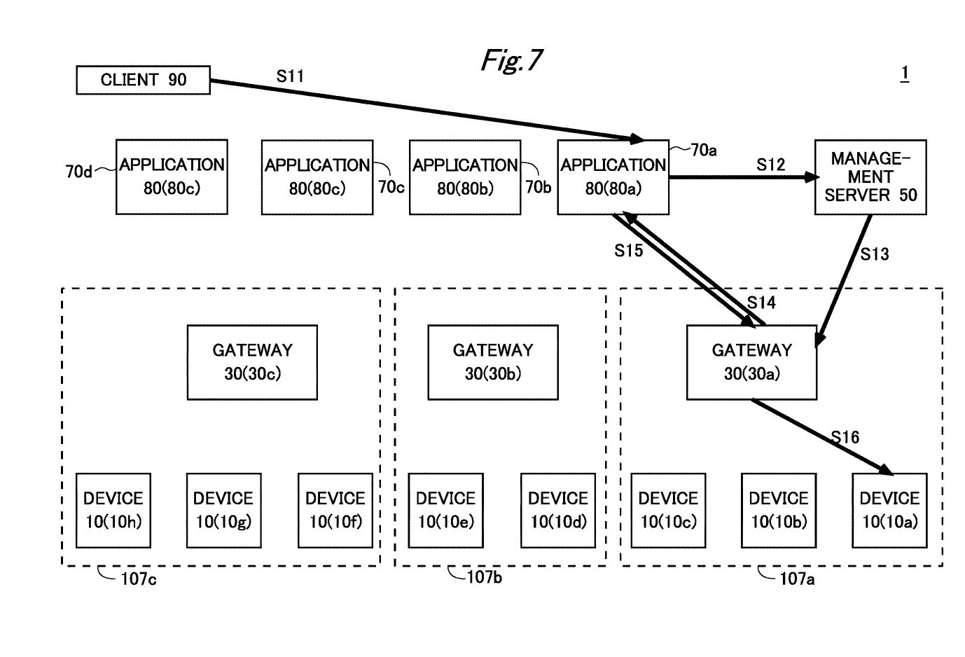

Such operations will now be described with reference mainly to FIG. 7. FIG. 7 illustrates operations relating to an “application-triggered communication request.”

As described above (see FIG. 5), the gateway 30a first establishes the communication session (to be more specific, message session) 511 in advance with the management server 50, which is designated in advance, for example at the time of startup of the gateway 30a. More specifically, the gateway 30a transmits a request to establish a message session to the management server 50 designated in advance. If, in response to this, the management server 50 has approved the establishment request, the message session 511 is established between the gateway 30a and the management server 50 (see FIG. 5). In other words, the message session is established in response to access from the gateway 30 inside the LAN 107 to the management server 50 outside the LAN 107. One example of such a message session (communication session) is a message session using a communication protocol such as the extensible Messaging and Presence Protocol (XMPP).

The gateway 30a also transmits information, such as information about devices under the control of the gateway 30a (management target devices), to the management server 50 in advance. The management server 50 stores registration information that includes information about management target devices 10 under the control of each gateway 30 (information described in each device list), in the management table 69 (FIG. 4) stored in the storage 55.

Thereafter, when a user operation relating to “cloud printing” is performed in a client 90, the cloud server 70a (application 80a) receives an instruction based on the user operation from the client 90 (S11 in FIG. 7). In response to this instruction, the cloud server 70a (application 80a) transmits a communication request (access request) intended for the specific device 10a to the management server 50 (S12).

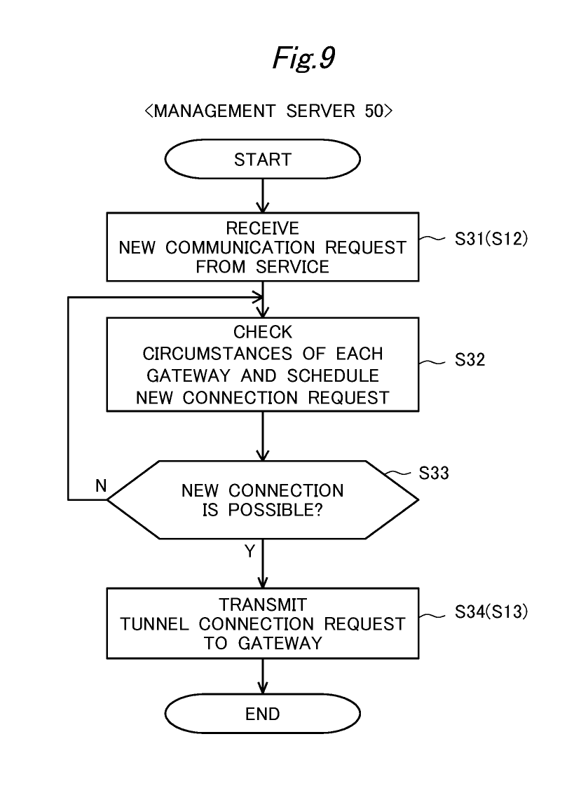

The management server 50 performs operations such as receiving the communication request (“application-triggered communication request”) from the cloud server 70 (application 80) (see FIG. 9). More specifically, when an application-triggered communication request is received from an application 80, the management server 50 determines subsequent operations on the basis of the standby-state information 110 (FIG. 12). To be more specific, the management server 50 determines which operation to perform; either the operation of immediately transmitting a connection request that is based on the application-triggered communication request to the gateway 30 or the operation of putting the transmission of the connection request on hold (steps S32 and S33 in FIG. 9). Details of the operations in FIG. 9 will be described later.

If the former operation is determined to be performed, the management server 50 transmits the tunnel connection request to the gateway 30 (S13 in FIG. 7). To be more specific, the management server 50 uses the message session (normally-connected communication session) 511 established between the management server 50 and the gateway 30 (30a) to transmit the tunnel connection request (e.g., connection request using XMPP) based on the access request to the gateway 30a. The term “tunnel connection request” as used herein refers to an instruction that requires the gateway 30 to establish a tunnel connection with the cloud server 70 (application 80). In other words, the tunnel connection request is an instruction that causes the gateway 30 to carry out communication using a tunnel connection.

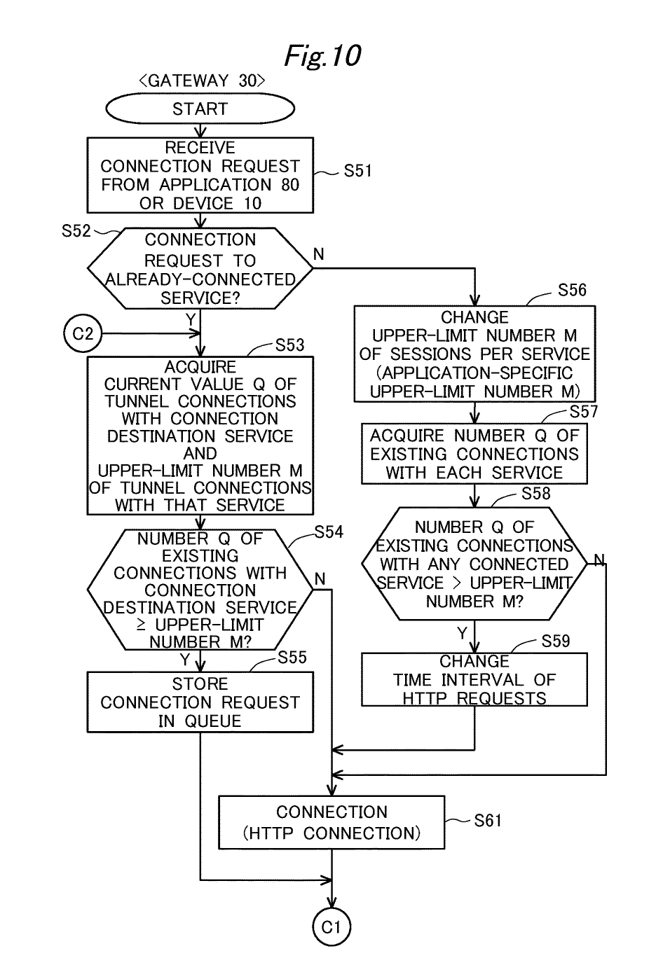

The gateway 30a that has received the tunnel connection request performs operations as illustrated in FIG. 10, which will be described later.

If a predetermined condition (described later) is satisfied, the gateway 30a establishes a tunnel connection (tunnel communication) with the cloud server 70a (application 80a) in response to the tunnel connection request (step S14 in FIG. 7; see also FIG. 6). In FIG. 6, the “tunnel communication” is schematically illustrated by a long and narrow rectangle with dot hatching.

To be more specific, in response to the tunnel connection request, the gateway 30a transmits a request to establish a hypertext transfer protocol (HTTP) session (to be more specific, a hypertext transfer protocol secure (HTTPS) session) to the cloud server 70a. Such a request to establish an HTTP (HTTPS) session is also referred to as a “tunnel-connection establishment request” from the gateway 30. Note that the “tunnel-connection establishment request” from the gateway 30 and the “tunnel connection request” from the management server 50 (or device 10) are different requests. The “tunnel-connection establishment request” from the gateway 30 is a request (instruction) that is issued to actually establish a tunnel connection from the gateway 30 to the cloud server 70 in response to the “tunnel connection request” from, for example, the management server 50.

If the cloud server 70a has approved the “tunnel-connection establishment request” from the gateway 30, a tunnel connection (tunnel communication) using the HTTP session is established between the gateway 30a and the cloud server 70a. In other words, the tunnel connection is established in response to the access from the gateway 30 inside the LAN 107 to the cloud server 70 outside the LAN 107.

Once the tunnel connection is established, the gateway 30a uses the tunnel connection to relay communication (mainly “downward” data communication) between the cloud server 70a and the device 10a (S15 and S16). To be more specific, the use of the tunnel communication via the HTTP (HTTPS) session will help the cloud server 70 to transmit various types of data to devices 10 (e.g., 10d) via the gateway 30.

In this way, tunnel communication is used to gain access from the cloud servers 70 (via the gateways 30) to the devices (image forming apparatuses) 10.

Note that examples of the application-triggered communication request include not only communication requests that relate to “cloud printing,” but also various types of communication requests. For example, the application-triggered communication requests include communication requests that relate to “pull printing” (to be more specific, operations of transmitting data to be printed), communication requests that relate to “status polling” in order to grasp the status of the devices 10, and communication requests that relate to “counter-information gathering services” in order to acquire counter information about the devices 10.

Operations Relating to Device-Triggered Communication Request (“Upward” Operations)

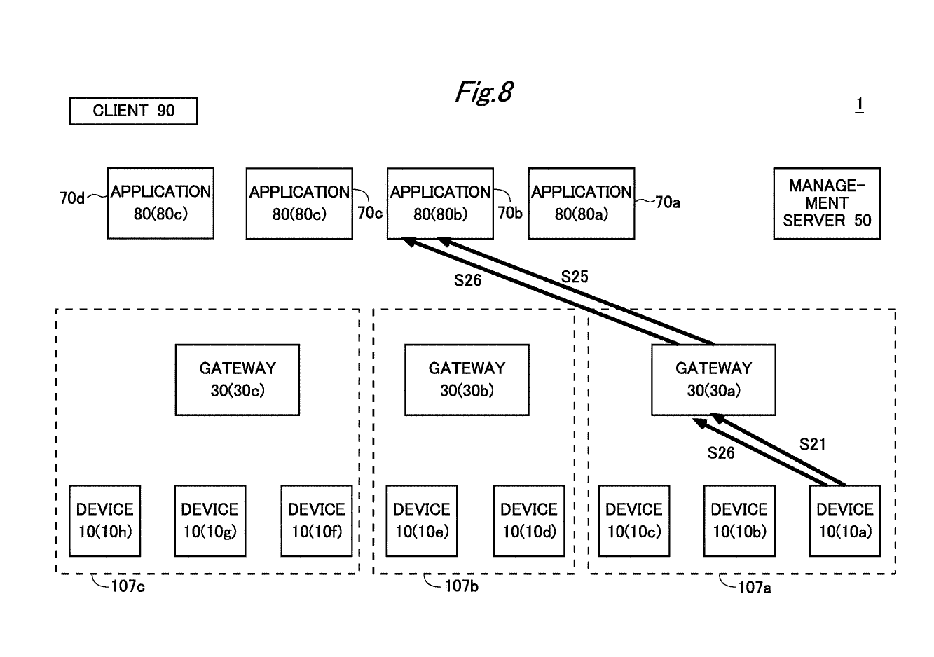

The communication system 1 also performs operations (operations relating to a “device-triggered communication request,” which will be described later) that are the “inverse” of the aforementioned operations relating to an “application-triggered communication request” (“downward” operations). The following describes such operations with reference to FIG. 8. Here, “cloud scanning” is mainly described as an example of processing that involves a device-triggered communication request.

More specifically, for example when a user operation relating to “cloud scanning” is performed in a device 10 (e.g., 10a), the device 10 transmits a communication request for an application 80 (e.g., 80b) that is operating in a cloud server 70 (e.g., 70b), to a gateway 30 (S21). The transmission of the communication request from the device 10 to the gateway 30 uses a communication protocol such as HTTP (and/or FTP).

This communication request is a communication request from the device 10 and is a request for communication that involves data transfer in a direction (upward) from the device 10 (via the gateway 30) to the application 80. The communication request is issued from the device 10 (i.e., the device serves as a trigger) and is thus also referred to as a “device-triggered communication request.” Here, it is assumed that when a “device-triggered communication request” has been received, it is determined that a “tunnel connection request” has been received. In other words, the receipt of a “device-triggered communication request” is regarded as the receipt of a tunnel connection request that is based on the “device-triggered communication request.”

Then, in response to the tunnel connection request, the gateway 30 forms (establishes) a tunnel connection with the cloud server 70b (application 80b) (step S25). The gateway 30 then uses the tunnel connection to relay communication (mainly “upward” data communication such as processing for uploading a scanned image) between the device 10a and the cloud server 70b (step S26).

In this way, processing that involves a device-triggered communication request is performed.

Note that examples of the device-triggered communication request include not only communication requests relating to “cloud scanning” but also various types of communication requests.

1-5. Control Operation Relating to Tunnel Connection Request

Operations of Management Server 50

FIG. 9 is a flowchart of operations performed by the management server 50. The operations of the management server 50 will now be described with reference to FIG. 9.

The management server 50 first receives a new communication request from an application 80 in step S31 (see also step S12 in FIG. 7).

Then, the management server 50 references the management table 69 and acquires the load condition of each gateway 30 (e.g., connection standby state of each gateway 30; standby state for connection requests based on received communication requests) in step S32. Note that the management table 69 stores (updates) the load condition of each gateway 30, which is transmitted at any time from the gateway 30, whenever necessary.

In step S32, the management server 50 schedules the new connection request received in step S31. More specifically, the management server 50 determines whether or not to immediately transmit the new connection request received in step S31 to a gateway 30 that corresponds to the new connection request.

FIG. 12 illustrates part of the information stored in the management table 69 (i.e., information (standby-state information) 110 about the load condition of each gateway 30). As illustrated in FIG. 12, the standby-state information 110 stores the load condition of each of the multiple gateways such as 30a, 30b, and 30c. The standby-state information 110 stores the load condition (here, the presence or absence of queued connection requests) of each gateway for each application. In other words, the load condition of each gateway is listed on an application-by-application basis.

FIG. 12 shows that the tunnel connection between the gateway 30a and the application 80a (also referred to as “Application A1”) is “Busy,” which means the presence of queued connection requests (“Queued Connection”). On the other hand, the tunnel connection between the gateway 30a and the application 80b (also referred to as “Application A2”) is not “Busy”, which indicates the absence of queued connection requests (“No Queue”). It is also shown that the tunnel connection between the gateway 30a and the application 80c (also referred to as “Application A3”) is not “Busy,” which indicates the absence of queued connection requests (“No Queue”).

If the load condition of the gateway (corresponding gateway) 30 to which the new connection request is to be transmitted, i.e., the load condition of communication with the application 80 from which the new connection request has been transmitted, indicates “Queued Connection” (“Busy”), the management server 50 determines that the gateway 30 is not available for processing of the new connection request. In this case, the management server 50 puts the transmission of the new connection request to the corresponding gateway 30 on hold. After the elapse of a fixed period of time, the procedure returns to step S32, and the determination processing is performed again.

For example, if, in the situation shown in FIG. 12, a new communication request to the gateway 30a is received from the application 80a (Application A1) (i.e., in the presence of a queued connection request), the management server 50 determines that the gateway 30a is not available for new connection. The management server 50 then puts the transmission of the new connection request to the corresponding gateway 30a on hold.

As will be described later, each gateway 30 controls operations that are performed in response to a tunnel connection request. In particular, if the load of communication between a gateway 30 and a specific application is high, the gateway 30 will reduce the occurrence of a load increase that might be caused by communication with the specific application, by not making a tunnel connection with the specific application. In addition to this, in the present embodiment, the management server 50 controls whether or not to transmit a new tunnel connection request. To be more specific, if there is a queue of tunnel connections between a gateway 30 and a specific application 80, the management server 50 does not transmit tunnel connection requests for the specific application 80 to the gateway 30. This avoids an increase of the load on the gateway 30 in advance.

On the other hand, if the load condition of the gateway (corresponding gateway) 30 to which the new connection request is to be transmitted, i.e., the load condition of communication with the application 80 from which the new connection request has been transmitted, indicates “No Queue” (“Not Busy”), the management server 50 determines that the gateway 30 is available for new connection, and the procedure proceeds to step S34. In step S34 (step S13), the management server 50 immediately transmits the new connection request to the gateway 30 (e.g., gateway 30a) that corresponds to the new connection request (see also step S13 in FIG. 7).

For example, if, in the situation shown in FIG. 12, a new communication request to the gateway 30a is received from the application 80b (Application A2) (i.e., in the absence of queued connection requests), the management server 50 determines that the gateway 30a is available for new connection. The management server 50 then transmits the new connection request to the gateway 30a by using a normally-connected message session (e.g., XMPP) in step S34 (see step S13 in FIG. 7).

As described so far, the tunnel connection requests based on the “application-triggered communication requests” are transmitted from the applications 80 via the management server 50 to the gateways 30 (see step S13 in FIG. 7). Note that the management server 50 uses a communication protocol such as XMPP to transmit the tunnel connection requests based on the “application-triggered communication requests” to the gateways 30.

Also, as described above, the tunnel connection requests based on the “device-triggered communication requests” are directly transmitted from the devices 10 to the gateways 30 (see step S21 in FIG. 8). Note that the devices 10 use a communication protocol such as HTTP to transmit the tunnel connection requests based on the “device-triggered communication requests” to the gateways 30.

In this way, various types of communication requests are transmitted at any time from either the applications 80 or the devices 10 to the gateways 30. Then, the gateways 30 receive tunnel connection requests based on the various types of communication requests.

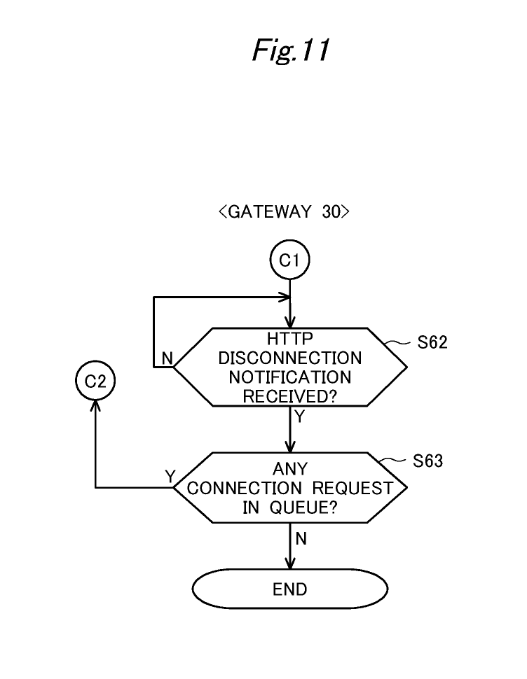

When such tunnel connection requests are received, the gateways 30 control operations of individual connections (tunnel connections) based on the tunnel connection requests (see FIGS. 10 and 11). FIGS. 10 and 11 are flowcharts of operations performed by the gateways 30. The following describes the operations of the gateways 30 with reference to FIGS. 10 and 11.

Operations of Gateway 30

When a tunnel connection request that is based on either an “application-triggered communication request” or a “device-triggered communication request” is received (step S51), a gateway 30 determines whether the tunnel connection request relates to an application (service) that already has connection with the gateway 30 (step S52). For example, it is assumed here that the gateway 30 already has a tunnel connection with the two applications 80a and 80b. If a tunnel connection request to another application 80c is received, the gateway 30 determines that the tunnel connection request does not relate to any application (80a or 80b) that already has connection with the gateway 30. In the same case, if a tunnel connection request to the application 80a is received, the gateway 30 determines that the tunnel connection request relates to the application (80a) that already has connection with the gateway 30.

If it is determined that the tunnel connection request relates to the application (service) that already has connection with the gateway, the procedure proceeds to step S53. On the other hand, if it is determined that the tunnel connection request relates to an application (in short, “new application”) other than the applications that already have connection with the gateway, the procedure proceeds to step S56.

Here, the “application-specific upper-limit number M” will be described first before description of operations performed in steps S53 and S56.

In the present embodiment, the upper-limit number M for each application (“also referred to as the “application-specific upper-limit number”) is used to control the operations of individual connections. The application-specific upper-limit number M is an upper-limit number for each application and an upper-limit number of individual connections that can be established between each gateway 30 (e.g., 30a) and each of one or more applications 80. The application-specific upper-limit number M is determined on the basis of the circumstances of establishment of individual connection (tunnel connection) between the gateway 30 (30a) and each application 80.

The application-specific upper-limit number M is changed according to the number of applications (services) that have an individual connection with the gateway. To be more specific, the application-specific upper-limit number M is determined on the basis of the maximum throughput of the gateway 30 (the maximum number X of individual connections that can be established between the gateway 30 and one or more applications) and a current number N of applications that have established an individual connection with the gateway 30.

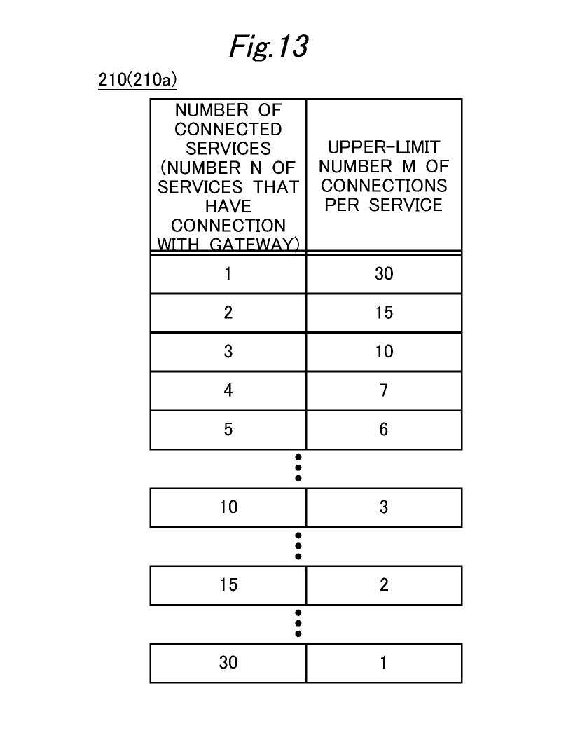

FIG. 13 illustrates an upper-limit number setting table 210 (210a). FIG. 13 illustrates a case where the maximum throughput of the gateway 30 (the maximum number X of individual connections that can be established between the gateway 30 and one or more applications) is “30.”

The upper-limit number setting table 210 (210a) in FIG. 13 is a data table that defines in advance the relationship between the number N of services that already have connection and the application-specific upper-limit number M. It is assumed that the upper-limit number setting table 210 (210a) as illustrated in FIG. 13 is stored in advance in the storage of the gateway 30. The left column in FIG. 13 indicates the number N of services that already have connection (the number of applications that already have a tunnel connection with the gateway 30). The right column indicates the application-specific upper-limit number M.

Here, the application-specific upper-limit number M is determined by dividing (to be more specific, equally dividing) the value X (the maximum number of individual connections that can be established with the gateway 30) into multiple applications that currently have an individual connection with the gateway 30.

To be more specific, the application-specific upper-limit number M is calculated by dividing the value X by the number N (and dropping the fractional portion of the number) (M=X/N). For example, if the number N is “1,” the application-specific upper-limit number M is “30” (=30/1), and if the number N is “2,” the application-specific upper-limit number M is “15” (=30/2). Similarly, if the number N is “3,” the application-specific upper-limit number M is “10” (=30/3), and if the number N is “4,” the application-specific upper-limit number M is “7” (≈30/4). If the number N is “10,” the application-specific upper-limit number M is “3” (=30/10), and if the number N is “15,” the application-specific upper-limit number M is “2” (=30/15). If the number N is “30,” the application-specific upper-limit number M is “1” (=30/30).

In this way, the application-specific upper-limit number M decreases as the number N of applications that already have connection increases. In other words, the upper-limit number M of tunnel connections per application gradually decreases with increasing number N.

Referring back to FIG. 10, if it is determined that the new tunnel connection request relates to a service that already has connection with the gateway, the procedure proceeds from step S52 to step S53 as described above.

In step S53, the (current) application-specific upper-limit number M is acquired. More specifically, the gateway 30 determines and acquires the application-specific upper-limit number M on the basis of the upper-limit number setting table 210 (210a) (FIG. 13). In step S53, the gateway 30 also acquires the number Q of (existing) individual connections (tunnel connections) already established with the application 80 (e.g., 80a) that corresponds to the new tunnel connection request (step S51). The gateway 30 then determines the size relation of the numbers Q and M in step S54.

If the number Q of existing tunnel connections with the application 80 (80a) that corresponds to the new connection request is greater than or equal to the (current) application-specific upper-limit number M, the gateway 30 determines to avoid an increase of the load on the application 80a, and the procedure proceeds from step S54 to step S55. In step S55, the gateway 30 determines not to establish a new individual connection with the corresponding application 80 (80a) as of now, and puts this tunnel connection request in a queue. The gateway 30 also transmits latest information about the queue (load condition of the gateway 30) to the management server 50. To be more specific, the gateway 30 transmits, to the management server 50, information indicating the presence of queued individual connections between the gateway 30a and the application 80a. On the basis of the latest information received from the gateway 30, the management server 50 updates the standby-state information 110 about the load condition of the gateway 30 (30a).

For example, when the gateway 30 already has an individual tunnel connection with the two applications 80a and 80b, the application-specific upper-limit number M is “15.” If the number Q of existing tunnel connections with the application 80 (80a) corresponding to the new connection request has already reached “15,” a connection request for the sixteenth tunnel connection is put in a queue. In this way, if it is determined that the load of communication between the gateway 30 and the specific application 80a is equal to or higher than a certain degree, the gateway 30 does not establish a tunnel connection with the specific application. This reduces the occurrence of a load increase that might be caused by communication with the specific application 80a.

On the other hand, if the number Q of existing tunnel connections with the application 80 (80a) corresponding to the new connection request is less than the current application-specific upper-limit number M, the procedure proceeds from step S54 to step S61. In step S61, the gateway 30 determines to establish a new individual connection with the corresponding application 80 (80a). The gateway 30 then transmits a tunnel-connection establishment request to the cloud server 70a (the cloud server 70 corresponding to the application 80a) and establishes a tunnel connection with the cloud server 70a.

For example, when the gateway 30 already has an individual tunnel connection with the two applications 80a and 80b, the application-specific upper-limit number M is “15.” If the number Q of existing tunnel connections with the application 80 (80a) corresponding to the new connection request is less than “15” (e.g., “10”), a request to establish the eleventh tunnel connection is transmitted to the cloud server 70a. Accordingly, a tunnel connection is established with the cloud server 70a (application 80a).

After steps S54 and S61 or step S55, the procedure proceeds to step S62 (FIG. 11). Processing in step S62 and onward will be described later.

Referring back to FIG. 10, if it is determined that the tunnel connection request received in step S51 relates to a “new application” (application other than the applications that already have connection), the procedure proceeds from step S52 to step S56 as described above.

In step S56, following the receipt of the tunnel connection request relating to the new application (service), the number N of applications that already have connection with the gateway is incremented by one, and the application-specific upper-limit number M is updated. For example, when the number N is increased from “2” to “3,” the application-specific upper-limit number M is reduced from “15” to “10” (see FIG. 13). Note that the time when a tunnel connection is actually established with the new application (service) in response to the tunnel connection request relating to the new application (the time when the number of applications that already have connection is increased) is strictly the subsequent step S61 (the time immediately after step S56). However, in the present embodiment, the application-specific upper-limit number M is updated in step S56 (by incrementing the number N by one), assuming that the number of applications that already have connection is already increased in step S56.

In the following step S57, the gateway 30 acquires the number of existing tunnel connections for each application. In other words, the gateway 30 acquires the number Q of existing tunnel connections (individual connections) for each application, which is also referred to as the number of existing connections (or existing sessions) for each application.

Then, in step S58, the gateway 30 determines the size relation of the numbers M and Q for each existing application (each application that already has a tunnel connection with the gateway 30). In other words, the number Q of existing connections for each application and the application-specific upper-limit number M are compared for each existing application 80.

If the numbers Q of existing connections for all applications are less than or equal to the updated application-specific upper-limit number M, the procedure proceeds from step S58 to step S61. In step S61, the operations as described above are performed. More specifically, the gateway 30 determines to establish a new individual connection with the corresponding application 80a, transmits a tunnel-connection establishment request to the cloud server 70a, and establishes a tunnel connection with the cloud server 70a.

For example, assume a situation where the gateway 30 (30a) already has an individual tunnel connection with the two applications 80a and 80b, and a new tunnel connection request to another application 80c is received in step S51. It is also assumed that the number of individual tunnel connections between the gateway 30 and the application 80a is “8,” and the number of individual tunnel connections between the gateway 30 and the application 80b is “7.”

If, in this situation, a new tunnel connection request is received from the new application 80c, the number N is increased from “2” to “3” and the application-specific upper-limit number M is changed (reduced) from “15” to “10” (step S56). In this case, the numbers Q of existing connections for the applications 80a and 80b, which are respectively “8” and “7,” are both less than or equal to the updated application-specific upper-limit number M, which is “10.” Thus, the procedure proceeds from step S58 to step S61. In this case, the number of individual connections for any application has not yet reached the upper-limit number, and therefore a tunnel connection with the application 80c is established while maintaining the existing tunnel connections.

On the other hand, if the number Q of existing connections for at least one application is greater than the updated application-specific upper-limit number M, the procedure proceeds from step S58 to step S59.

For example, assume a situation where the gateway 30 (30a) already has an individual tunnel connection with the two applications 80a and 80b and a new tunnel connection request to another application 80c is received in step S51. It is also assumed that the number of individual tunnel connections between the gateway 30 and the application 80a is “14,” and the number of individual tunnel connections between the gateway 30 and the application 80b is “7.”

If, in this situation, a new tunnel connection request is received from the new application 80c, the number N is increased from “2” to “3,” and the application-specific upper-limit number M is changed (reduced) from “15” to “10.” As a result, it is determined that the number Q of existing connections for the application 80a, which is “14,” is greater than the updated application-specific upper-limit number M, which is “10,” while the number Q of existing connections for the application 80b, which is “7,” is less than the updated application-specific upper-limit number M, which is “10.” Thus, the procedure proceeds from step S58 to step S59. In this case, the load that relates to the tunnel connections with the application 80a, among the existing tunnel connections, is reduced in the next step S59, before a new tunnel connection with the (new) application 80c is established in the subsequent step S61.

In step S59, the gateway 30 changes (to be more specific, increases) the time interval of HTTP requests for tunnel connection (HTTP communication) between the gateway 30 and the application (also referred to as a “high-load application”) whose number Q of existing connections is greater than the application-specific upper-limit number M. For example, in the example just described above, the time interval of HTTP requests for tunnel connection with the high-load application 80a is changed to a value greater than the value before the change (e.g., default value) (i.e., changed to a longer time interval). Note that the time intervals of HTTP requests for tunnel connection with the other applications 80b and 80c remain unchanged (e.g., remain their default values).

Here, the time interval of HTTP requests will be described. In HTTP communication, data to be transmitted is divided into predetermined units of data volume (e.g., in units of 64 KB) to communicate the data in the multiple units. Each unit of communication sends a communication request. Step S59 intends to reduce the speed of communication (and accordingly reduces the load of communication) by increasing the time interval (time interval of HTTP requests) between each of the multiple units of communications. This reduces the load on the gateway 30.

To be more specific, in step S59, the time interval of HTTP requests may be increased by a factor of the inverse of the ratio of the application-specific upper-limit number M after the change to the application-specific upper-limit number M before the change (i.e., by a factor of the before-to-after-change ratio of the value M).

For example, when the application-specific upper-limit number M is reduced from “30” to “15,” the time interval of HTTP requests may be increased to a value that is the double of the default value (=30/15). When the application-specific upper-limit number M is further reduced from “15” to “10,” the time interval of HTTP requests may be increased to a value that is 1.5 times (=15/10) the previous value, which is the double of the default value, (i.e., increased to a value that is three times the default value). In this case, the tunnel connection between the gateway 30a and the application 80a whose number Q of existing connections is “14” is made at a longer time interval (e.g., 1.5 times) than the time interval of HTTP requests for tunnel connection before the updating of the upper-limit number M, which is “15.” Accordingly, the load of communication between the application 80a and the gateway 30 will be suppressed even if the number Q of existing connections for the application 80a, which is “14”, exceeds the new upper-limit number, which is “10.” As a result, it is possible to suppress the effect of the communication between the application 80a and the gateway 30 on the communication between the gateway 30 and other applications (e.g., 80b and 80c).

After step S58 or S59, the procedure proceeds to step S61. In step S61, the tunnel connection between the gateway 30 and the application 80c is actually established in response to the new tunnel connection request (step S51) to the application 80c. Then, the tunnel connection is used to carry out HTTP communication between the gateway 30 and the application 80c.

The procedure then proceeds to step S62 (FIG. 11). If the gateway 30 determines in step S62 that any existing tunnel connection (HTTP connection) has ended and a notification of disconnection of the tunnel connection (HTTP connection) is received, the procedure proceeds to step S63. In step S63, the gateway 30 determines the presence or absence of queued connection requests in the queue. In the absence of queued connection requests (unprocessed connection requests) in the queue, the processing in FIGS. 10 and 11 ends. On the other hand, in the presence of queued connection requests in the queue, the procedure returns to step S53 and processing is performed for the unprocessed connection request (e.g., step S61).

According to the embodiment described above, when a new tunnel connection request for connection with the application 80a is received, the gateway 30 establishes a new individual connection with the application 80a under a certain condition, in response to the tunnel connection request (see steps S54 and S61). More specifically, the new individual connection is established on condition that the total number Q of individual connections currently established between the application 80a and the gateway 30 is less than the application-specific upper-limit number M for the application 80a. Conversely, even if the tunnel connection request is received, a new individual connection with the application 80a will not be established if the number Q of connections for the application 80a is greater than or equal to the application-specific upper-limit number M for the application 80a, (see steps S54 and S55). Accordingly, even if application use is suddenly concentrated on the specific application 80a, adverse effects thereof on the users of other applications (e.g., 80b) can be avoided or suppressed.

In addition, in the presence of a high-load application (e.g., 80a) whose total number of individual connections currently established with the gateway 30 exceeds the application-specific upper-limit number M, the gateway 30 increases the interval of requests for communication (tunnel connection) between the high-load application 80a and the gateway 30.

To be more specific, the gateway 30 reduces the application-specific upper-limit number M when having received a connection request to further establish an individual connection with the application 80c other than the applications 80a and 80b that already have an individual connection with the gateway 30. If the reduction of the application-specific upper-limit number M causes a high-load application (e.g., 80a) to arise, the gateway 30 increases the interval of requests for communication between the high-load application 80a and the gateway 30.

This suppresses the load of communication using the tunnel connection with the application 80a, which is a new high-load application. Accordingly, even if the use of the specific application 80a is relatively increased, adverse effects thereof on users of other applications (e.g., 80b and 80c) can be avoided or suppressed.

### 2. Second Embodiment

2-1. Overview

A second embodiment is a variation of the first embodiment. The following description focuses mainly on differences from the first embodiment.

In the above-described first embodiment, the number of existing connections (the number of established tunnel connections) and the application-specific upper-limit number M are compared for each application, and operations that relate to tunnel connection are controlled on the basis of the comparison result. The present invention is, however, not limited to this example.

For example, the number of existing connections (the number of established tunnel connections) and a direction-specific upper-limit number (also referred to as a “type-specific upper-limit number”) M0, which will be described later, may be compared for each application and for each direction (in other words, type) of a communication request, which will be described later, and operations that relate to tunnel connection may be controlled on the basis of the comparison result. In this case, each individual connection (tunnel connection) is also controlled on a direction-by-direction basis (not only on an application-by-application basis). Thus, even if the use of individual connections in one direction (e.g., “downward”), among the individual conditions with an application, is relatively increased, adverse effects thereof on individual connections in the other direction (e.g., “upward”) or individual connections with other applications can be avoided or suppressed. The second embodiment describes such a mode.

In the second embodiment, the gateways 30 receive tunnel connection requests that are based on either “application-triggered communication requests” or “device-triggered communication requests” as described above. In other words, the gateways 30 receive tunnel connection requests that are based on at least either of requests to start “downward” data transmission and requests to start “upward” data transmission.

The direction-specific upper-limit number (type-specific upper-limit number) M0 is an upper-limit number on a direction-by-direction basis (on a type-by-type basis), obtained by dividing the application-specific upper-limit number M into two types of communication requests (communication requests in two directions), namely, “application-triggered communication requests” and “device-triggered communication requests.” The direction-specific upper-limit number M0 includes a direction-specific upper-limit number M01 for downward communication requests and a direction-specific upper-limit number M02 for upward communication requests.

In the second embodiment, each gateway 30 establishes a new individual connection with an application 80 (e.g., 80a) in response to a connection request, if only the following condition is satisfied. The condition is that a total number Q0 of connections, which will be described below, does not exceed the direction-specific upper-limit number M0 (M01 or M02) for the application 80a and for communication requests in a specific direction (or of a specific type). Here, the total number Q0 of connections refers to, out of the total number Q of individual connections currently established with the application 80 (e.g., 80a) corresponding to a new request, the number (Q0) of individual connections that are based on communication requests of the same type (specific type) as the communication request type of a connection request based on the new request (i.e., communication requests in the same direction (specific direction) as the communication request direction of the connection request). For example, a case is assumed in which the application 80a and a gateway 30 already have “six” tunnel connections based on “application-triggered communication requests” and “four” tunnel connections based on “device-triggered communication requests”, and the gateway 30 has further received a connection request (connection request based on a new request) based on an “application-triggered communication request” from the application 80a. At this time, the number of individual connections based on the communication requests (“application-triggered communication requests”) of the same type as the communication request type of the received connection request based on a new request, which is “six,” is calculated as the total number Q0 of connections.

Moreover, in the presence of a “direction-specific high-load application,” which will be described later, the gateway 30 increases the time interval of requests (to be more specific, for example, the time interval of HTTP requests) for communication between the direction-specific high-load application and the gateway. Here, the “direction-specific high-load application” (also referred to as “type-specific high-load application”) refers to an application whose total number of individual connections based on the communication requests in the same direction (of the same type) as the new connection request received in step S71, among the individual connections currently established with the gateway 30, exceeds the direction-specific upper-limit number (type-specific upper-limit number) M0.

2-2. Two Types of Communication Requests for Each Application

In the present embodiment, each single application (service) may involve the aforementioned two types of communication requests (to be more specific, “application-triggered communication requests” and “device-triggered communication requests”).

For example, services such as pull printing may involve the two types of communication requests.

In the pull printing service, after a user issues a print instruction by using a printing-request source device, the printing-request source device transfers print data to a server (here, a cloud server 70) so that the print data is temporarily stored in, for example, a storage (storage area for pull printing) of the server 70.

Thereafter, through a user authentication operation using, for example, an operation input unit of a printout device (here, a device 10), the print data is acquired (pulled) from the cloud server 70 and printed out (printed) by the printout device. To be more specific, after the user authentication operation is performed in the device 10, a request to transmit a list of documents to be printed (candidates for printing) is transmitted from the device 10 to the cloud server 70, and in response to the transmission request, the list (list of documents for pull printing) is transmitted from the cloud server 70 to the device 10. The list is then displayed on the device 10, and if a desired document to be printed is selected from the list by a user, print data about the selected document to be printed is transmitted from the cloud server 70 to the device 10 and used by the device (printout device) 10 to print out (print) the document.

An application 80 (e.g., 80a) that provides such a pull printing service may involve the aforementioned two types of communication requests (to be more specific, “application-triggered communication requests” and “device-triggered communication requests”). More specifically, communication in which a request to transmit a login user's list of documents for pull printing (information about the names of documents, which are candidates for printout) is transmitted from the device 10 to the cloud server 70 (application 80a) is carried out on the basis of a “device-triggered communication request.” On the other hand, processing for transmitting the print data from the cloud server 70 to the device 10 is performed on the basis of an “application-triggered communication request” in a direction from the application 80a to the device 10.

The same applies to the other applications, and each application (service) may involve the aforementioned two types of communication requests (to be more specific, “application-triggered communication requests” and “device-triggered communication requests”).

2-3. Direction-Specific Upper-Limit Number (Type-Specific Upper-Limit Number) M0

The second embodiment uses the direction-specific upper-limit number (type-specific upper-limit number) M0. The direction-specific upper-limit number M0 is an upper-limit number on a direction-by-direction basis, obtained by dividing the aforementioned application-specific upper-limit number M into the two types of communication requests, namely, “application-triggered communication requests” and “device-triggered communication requests.” The direction-specific upper-limit number M0 includes a direction-specific upper-limit number M01 for downward communication requests and a direction-specific upper-limit number M02 for upward communication requests.

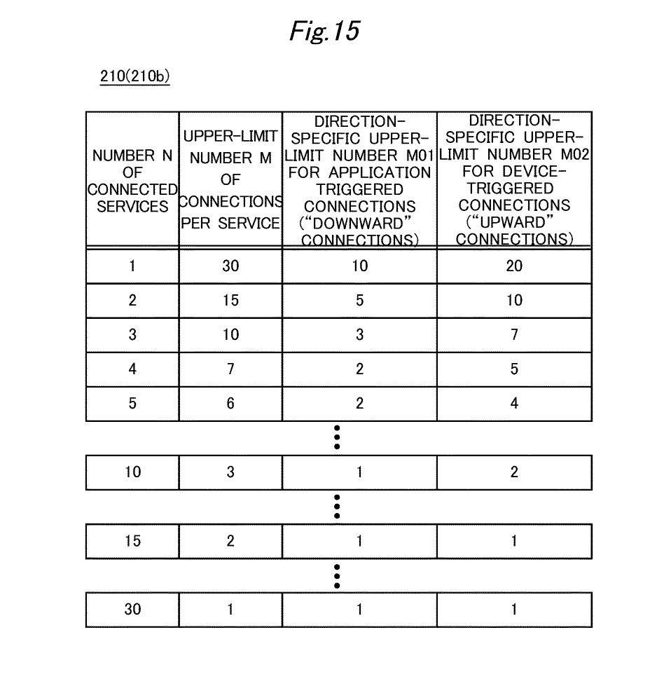

FIG. 15 illustrates an upper-limit number setting table 210 (210b) according to the second embodiment. FIG. 15 shows examples of the direction-specific upper-limit number M0. In the second embodiment, it is assumed that the upper-limit number setting table 210 (210b) as illustrated in FIG. 15 is stored in advance in the storage of each gateway 30.

The leftmost column in FIG. 15 indicates the number N of services that already have connection (the number of applications that already have a tunnel connection with the gateway 30). The column on the right of the leftmost column (the second column from the leftmost column in FIG. 15) indicates the application-specific upper-limit number M. A comparison with FIG. 13 shows that the leftmost column in FIG. 15 is the same as the left column in FIG. 13, and the second column from the leftmost column in FIG. 15 is the same as the right column in FIG. 13. FIG. 15 also illustrates the case where the maximum throughput of the gateway 30 (the maximum number X of individual connections that can be established between the gateway 30 and one or more applications) is “30.”

As indicated by the two columns on the right in FIG. 15, the application-specific upper-limit number M is divided into the upper-limit number (also referred to as “downward-communication upper-limit number”) M01 of tunnel connections that are based on “application-triggered communication requests” and the upper-limit number (also referred to as “upward-communication upper-limit number”) M02 of tunnel connections that are based on “device-triggered communication requests”. Here, each application-specific upper-limit number M that corresponds to the number N of connected applications (services) is divided in a predetermined ratio (approximately 1:2) into the downward-communication upper-limit number M01 and the upward-communication upper-limit number M02.

For example, if the number N is “1,” the corresponding application-specific upper-limit number M, which is “30,” is divided into “10” for the downward-communication upper-limit number M01 and “20” for the upward-communication upper-limit number M02.

Similarly, if the number N is “2,” the corresponding application-specific upper-limit number M, which is “15,” is divided into “5” for the downward-communication upper-limit number M01 and “10” for the upward-communication upper-limit number M02.

If the number N is “3,” the corresponding application-specific upper-limit number M, which is “10,” is divided into “3” for the downward-communication upper-limit number M01 and “7” for the upward-communication upper-limit number M02.

Similarly, the other application-specific upper-limit numbers M that correspond to the other numbers N are each divided in a predetermined ratio (in the present example, approximately 1:2) into the two types of upper-limit numbers M01 and M02.

When the number N is “30,” the corresponding application-specific upper-limit number M is “1.” If this value is completely divided into the two types, the direction-specific upper-limit number M0 (e.g., M01) in one direction is “0.” This will cause an inconvenience to the establishment of tunnel connection in that direction. Thus, in this case, the downward-communication upper-limit number M01 and the upward-communication upper-limit number M02 are both exceptionally set to “1.”

2-4. Detailed Operations

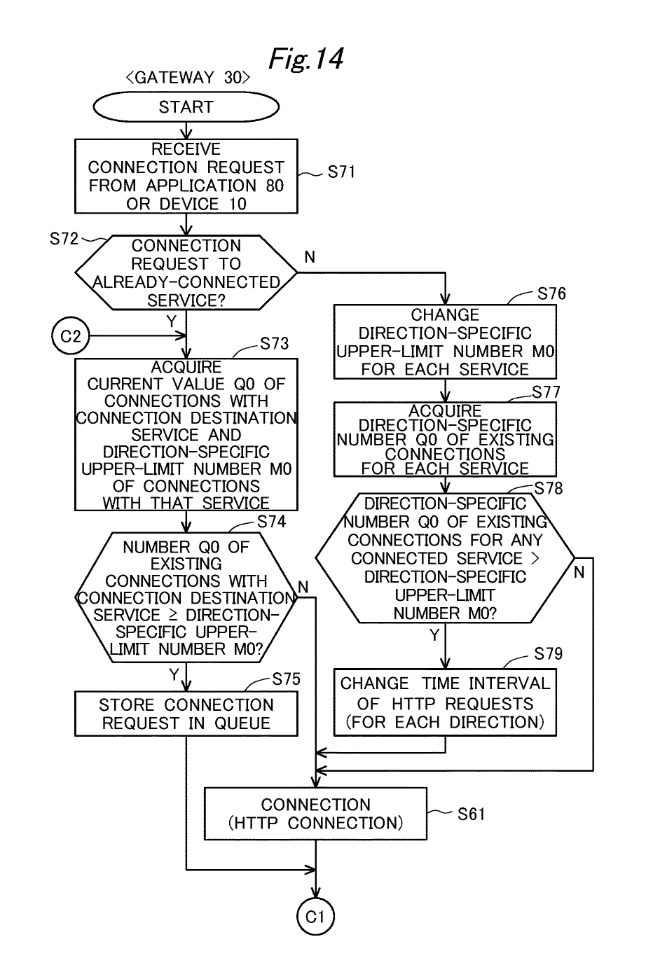

Next, further details of the operations of the gateway 30 according to the second embodiment will be described with reference to FIG. 14 and other drawings.

Processing performed in steps S71 to S79 in FIG. 14 is similar to that performed in steps S51 to S59 in FIG. 10. However, steps S71 to S79 according to the second embodiment differ from steps S51 to S59 according to the first embodiment in that each operation is controlled in consideration of whether each tunnel connection request is based on an “application-triggered communication request” or a “device-triggered communication request” as described above.

When a tunnel connection request that is based on either an “application-triggered communication request” or a “device-triggered communication request” is received in step S71, a gateway 30 determines in which direction the tunnel connection request is directed. That is, the gateway 30 determines whether the received tunnel connection request is based on an “application-triggered communication request” (downward communication request) or a “device-triggered communication request” (upward communication request).

More specifically, the direction (orientation) of a communication request that forms the basis of the received tunnel connection request is determined on the basis of a communication protocol used for the tunnel connection request. To be more specific, tunnel connection requests that are received using protocols such as XMPP (protocols used in normally-connected message sessions) are determined as tunnel connection requests based on “application-triggered communication requests” (downward communication requests). On the other hand, tunnel connection requests that are received using protocols such as HTTP (and/or FTP) (protocols used in occasionally-connected message sessions) are determined as tunnel connection requests based on “device-triggered communication requests” (upward communication requests).

In step S72, the gateway 30 determines whether the tunnel connection request relates to a service (application) that already has connection.

If it is determined that the tunnel connection request relates to an application (service) that already has connection, the procedure proceeds to step S73. On the other hand, if it is determined that the tunnel connection request relates to an application (in short, “new application”) other than the applications that already have connection, the procedure proceeds to step S76.

In step S73, the gateway 30 acquires the current direction-specific upper-limit number M0. More specifically, the gateway 30 determines and acquires the direction-specific upper-limit number M0 on the basis of the upper-limit number setting table 210 (210b) (FIG. 15). For example, when the number N of connected services is “1,” the application-specific upper-limit number M is “30,” the downward-direction-specific upper-limit number M01 is “10,” and the upward-direction-specific upper-limit number M02 is “20.”

In step S73, the gateway 30 also acquires the total number Q0 of individual connections that are based on the communication requests of the same type (in the same direction) as the communication request received in step S71, from among the tunnel connections (individual connections) currently established between the gateway 30 and the application 80 (e.g., 80a) that corresponds to the new tunnel connection request (step S71).

The gateway 30 then determines the size relation of the number M0 (M01 or M02) and the number Q0 in step S74.

If the total number Q0 of connections is greater than or equal to the direction-specific upper-limit number M0 (e.g., M01) (i.e., the upper-limit number for the application that corresponds to the connection request received in step S71 and for connection requests that are based on the communication requests of the same type as the received connection request), the procedure proceeds from step S74 to step S75. In step S75, the gateway 30 determines not to yet establish a new individual connection with the corresponding application 80 (80a), and puts this tunnel connection request in a queue. The gateway 30 also transmits the latest information about the queue (load condition of the gateway 30) to the management server 50. To be more specific, the gateway 30 transmits, to the management server 50, information indicating the presence of a queued individual connection between the gateway 30a and the application 80a. On the basis of the latest information received from the gateway 30, the management server 50 updates the standby-state information 110 about the load condition of the gateway 30 (30a).

For example, when the gateway 30 already has an individual tunnel connection with the two applications 80a and 80b, the application-specific upper-limit number M is “15” and the downward-direction-specific upper-limit number M01 is “10.” If a new connection request is a “downward” connection request and if the total number Q0 of “downward” connections out of the number Q of existing tunnel connections for the application 80 (80a) corresponding to the new connection request has already reached “10,” the eleventh “downward” connection request will be put in a queue.

On the other hand, if the total number Q0 of connections is less than the direction-specific upper-limit number M0 (e.g., M01), the procedure proceeds from step S74 to step S61. In step S61, the gateway 30 determines to establish a new individual connection with the corresponding application 80 (80a). The gateway 30 then transmits a tunnel-connection establishment request to the cloud server 70a (the cloud server 70 that corresponds to the application 80a) and establishes a tunnel connection with the cloud server 70a.

For example, when the gateway 30 already has an individual tunnel connection with the two applications 80a and 80b, the application-specific upper-limit number M is “15” and the downward-direction-specific upper-limit number M01 is “10.” If a new connection request is a “downward” connection request and if the total number Q0 of “downward” connections out of the numbers Q of existing tunnel connections for the application 80 (80a) corresponding to the new connection request is less than “10” (e.g., “5”), the procedure proceeds to step S61. In step S61, a request to establish the sixth tunnel connection is transmitted to the cloud server 70a in response to the sixth “downward” connection request. Accordingly a tunnel connection is established with the cloud server 70a (application 80a).

In this way, in response to a connection request, a new individual connection is established with the application corresponding to the connection request, on condition that the direction-specific total number Q0 of connections is less than the direction-specific upper-limit number M0 (e.g., M01) (the upper-limit number for the application that corresponds to the connection request received in step S71 and for connection requests based on the communication requests of the same type as the connection request).

After steps S74 and S61 or step S75, the procedure proceeds to step S62 (FIG. 11).

Referring back to FIG. 14, if it is determined that the tunnel connection request relates to an application (in short, “new application”) other than the applications that already have connection, the procedure proceeds from step S72 to step S76, as described above.

In step S76, the number N of applications that already have connection is incremented by one and the application-specific upper-limit number M is updated in the same manner as in step S56. For example, when the number N is increased from “2” to “3,” the application-specific upper-limit number M is reduced from “15” to “10.” Along with this, the downward-direction-specific upper-limit number M0 (M01) is reduced from “5” to “3,” and the upward-direction-specific upper-limit number M0 (M02) is reduced from “10” to “7.”

In step S77, the gateway 30 acquires the number of existing tunnel connections on an application-by-application basis. In other words, the gateway 30 acquires the number Q of existing tunnel connections (individual connections) for each application (also referred to as the number Q of existing connections for each application). In particular, in step S77, the direction-specific number Q0 of existing connections for each application is acquired. More specifically, the gateway 30 acquires the number Q01 of existing “downward” connections and the number Q02 of existing “upward” connections for each application.

Then, in step S78, the gateway 30 determines the size relation of the numbers M0 and Q0 for each existing application (application that has already established a tunnel connection with the gateway 30) and for each direction of communication requests.

More specifically, the direction-specific number Q0 of existing connections and the direction-specific upper-limit number M0 are compared for each existing application 80.

To be more specific, first, the number Q01 of existing “downward” connections and the downward-direction-specific upper-limit number M0 are compared for each existing application 80. Moreover, the number Q02 of existing “upward” connections and the upward-direction-specific upper-limit number M02 are compared for each existing application 80.

If the direction-specific numbers Q0 of existing connections for all applications (to be more specific, for both directions) are less than the updated direction-specific upper-limit number M0, the procedure proceeds from step S78 to step S61. In step S61, operations as described above are performed. More specifically, the gateway 30 determines to establish a new individual connection with the corresponding application 80a, transmits a tunnel-connection establishment request to the cloud server 70a, and establishes a tunnel connection with the cloud server 70a.

For example, assume a situation where the gateway 30 (30a) already has an individual tunnel connection with the two applications 80a and 80b, and a new tunnel connection request to another application 80c is received in step S71. It is also assumed that, among the individual tunnel connections established between the gateway 30 and the application 80a, the number of “downward” connections is “3” and the number of “upward” connections is “5.” Yet another assumption is that, among the individual tunnel connections established between the gateway 30 and the application 80b, the number of “downward” connections is “2” and the number of “upward” connections is “5.”

If, in this situation, a new tunnel connection request is received from the new application 80c, the number N is increased from “2” to “3” and the application-specific upper-limit number M is changed (reduced) from “15” to “10” (step S76). The direction-specific upper-limit numbers M0 are also changed. More specifically, the downward-direction-specific upper-limit number M01 is reduced from “5” to “3,” and the upward-direction-specific upper-limit number M02 is reduced from “10” to “7.”

In this case, the numbers Q01 of existing “downward” connections for the applications 80a and 80b, which are respectively “3” and “2,” are both less than or equal to the updated downward-direction-specific upper-limit number M01, which is “3.” The numbers Q02 of existing “upward” connections for the applications 80a and 80b, which are both “5,” are also less than or equal to the updated upward-direction-specific upper-limit number M02, which is “7.” Thus, the procedure proceeds from step S78 to step S61.

On the other hand, if the direction-specific number Q0 of existing connections for at least one application (to be more specific, for at least one “direction”) is greater than or equal to the updated direction-specific upper-limit number M0, the procedure proceeds from step S78 to step S79.

For example, assume a situation where the gateway 30 (30a) already has an individual tunnel connection with the two applications 80a and 80b, and a new tunnel connection request to another application 80c is received in step S71. It is also assumed that, among the individual tunnel connections established between the gateway 30 and the application 80a, the number Q01 of “downward” connections is “5” and the number Q02 of “upward” connections is “7.” Yet another assumption is that, among the individual tunnel connections established between the gateway 30 and the application 80b, the number Q01 of “downward” connections is “2” and the number Q02 of “upward” connections is “5.”

If, in this situation, a new tunnel connection request is received from the new application 80c, the number N is increased from “2” to “3” and the application-specific upper-limit number M is changed (reduced) from “15” to “10” (step S76). The direction-specific upper-limit numbers M0 are also changed. More specifically, the downward-direction-specific upper-limit number M01 is reduced from “5” to “3,” and the upward-direction-specific upper-limit number M02 is reduced from “10” to “7.”

In this case, it is determined that the (direction-specific) number Q01 of existing “downward” connections for the application 80a, which are “5,” is greater than the updated upward-direction-specific upper-limit number M01, which is “3.” In other words, the gateway 30 determines the presence of an application (“direction-specific high-load application”) (e.g., 80a) whose total number Q0 of individual connections based on communication requests of a predetermined type (e.g., “downward” communication requests), among the individual connections currently established with the gateway 30, exceeds the direction-specific upper-limit number M0 for the communication requests of the predetermined type. Note that the “direction-specific high-load application” is also referred to as a “type-specific high-load application.”

As a result of this determination, the procedure proceeds from step S78 to step S79.

In step S79, the gateway 30 increases the time interval of requests for communication connection that is established between the direction-specific high-load application (80a) and the gateway 30 and that corresponds to a communication request of a predetermined type. For example, in the example just described above, the time interval of HTTP requests for “downward” tunnel connection with the high-load application 80a is changed to a value greater than the value before the change (e.g., default value) (i.e., changed to a longer time interval). For example, the time interval of HTTP requests may be increased by a factor of the inverse of the ratio of the direction-specific upper-limit number M0 after the change to the direction-specific upper-limit number M0 before the change (i.e., by a factor of the before-to-after-change ratio of the value M0).

Note that the number Q02 of existing “upward” connections for the application 80a, which is “7,” is determined to be less than or equal to the updated upward-direction-specific upper-limit number M02, which is “5.” Thus, the time interval of HTTP requests for “upward” tunnel connections with the application 80a remains unchanged. Also, the number Q01 of existing “downward” connections for the application 80b, which is “2,” is determined to be less than or equal to the updated downward-direction-specific upper-limit number M01, which is “3,” and the number Q02 of existing “upward” connections for the application 80b, which is “5,” is determined to be less than or equal to the updated upward-direction-specific upper-limit number M02, which is “7.” Thus, the time interval of HTTP requests for tunnel connection with the application 80b remains unchanged for either direction. Moreover, the time interval of HTTP requests for tunnel connection with the other application 80c also remains unchanged.

In this way, in the presence of a direction-specific high-load application whose number Q0 of existing connections for a predetermined direction is greater than the direction-specific upper-limit number M0, the gateway 30 increases the time interval of requests for communication (tunnel connection) that is established between the direction-specific high-load application and the gateway 30 and that corresponds to a communication request in the predetermined direction.

After step S78 or step S79, the procedure proceeds to step S61. In step S61, a tunnel connection is established between the gateway 30 and the application 80c in response to the new tunnel connection request to the application 80c (step S71). Then, the tunnel connection is used to carry out HTTP communication between the gateway 30 and the application 80c.

Processing in step S62 and onward is performed in the same manner as in the first embodiment.

According to the above-described embodiment, when a new tunnel connection request for connection with the application 80a is received, the gateway 30 establishes a new individual connection with the application 80a under a certain condition, in response to the tunnel connection request (see steps S74 and S61). More specifically, the new individual connection is established on condition that, among the individual connections currently established between the application 80a and the gateway 30, the total number Q0 of tunnel connections that are based on communication requests of a specific type (in a specific direction) that is the same type as the communication request type of the new tunnel connection request is less than the direction-specific upper-limit number (type-specific upper-limit number) M0 for the application 80a and for the communication requests of the specific type. Conversely, even if the tunnel connection request is received, a new tunnel connection with the application 80a will not be established if the number Q0 of existing tunnel connections with the application 80a that are based on the communication requests of the same type (specific type) as the new tunnel connection request is greater than or equal to the direction-specific upper-limit number M0 for the application 80a and for the specific type (specific direction) (see steps S74 and S75).

Accordingly, even if application use is suddenly concentrated on the specific application 80a (in particular, communication requests in a specific direction), adverse effects thereof on users of other applications (e.g., 80b) can be avoided or suppressed. Also, even if connection use is suddenly concentrated on tunnel connections with the specific application 80a in a specific direction, adverse effects thereof on tunnel connections in the other direction different from the specific direction (tunnel connections of a different trigger type) can be avoided or suppressed.

In addition, in the presence of a “direction-specific high-load application” (e.g., 80a) as described above, the gateway 30 increases the time interval of requests for tunnel connection (communication) between the high-load application 80a and the gateway 30. To be more specific, the gateway 30 reduces the direction-specific upper-limit number M0 when having received a connection request to further establish an individual connection with the application 80c other than the applications 80a and 80b that already have an individual connection with the gateway 30. Then, if the reduction of the direction-specific upper-limit number M0 causes a direction-specific high-load application in a specific direction (e.g., 80a) to arise, the gateway 30 increases the interval of requests for specific communication connection. The “specific communication connection” as used herein refers to communication connection that is established between the direction-specific high-load application 80a and the gateway 30 and that corresponds to a communication request in the specific direction.

This suppresses the load of communication in the specific direction of the tunnel connection with the application 80a, which is a new direction-specific high-load application. Thus, even if the use of the specific application 80a (to be more specific, the tunnel connection request based on the communication request in the specific direction) is relatively increased, adverse effects thereof on users of other applications (e.g., 80b and 80c) can be avoided or suppressed. It is also possible to avoid adverse effects on communication with the specific application 80a in the direction other than the predetermined direction. For example, when the time interval of HTTP requests for only “downward” communication is changed, adverse effects on “upward” communication (device-triggered communication) can be avoided or suppressed.

In step S76 described above, the gateway 30 determines the direction-specific upper-limit number M0 in accordance with the upper-limit number setting table 210b in FIG. 15. More specifically, the gateway 30 determines that the direction-specific upper-limit number M02 for “upward” communication requests (“device-triggered communication requests”), among communication requests in the two directions (of the two types), be greater than the direction-specific upper-limit number M01 for “downward” communication requests (“application-triggered communication requests”).

In general, immediacy is often more demanded in communication using tunnel connections that are based on device-triggered communication requests require than in communication using tunnel connections that are based on application-triggered communication requests. For example, in the aforementioned pull printing, tunnel connections that are based on “device-triggered communication requests” are used for transmission of a login user's list of documents for pull printing (information about document names of printout candidates). In particular, quick response (i.e., quick display in response to a user operation) is often demanded when displaying a screen based on the list of documents for pull printing.

In view of this, in the above-described embodiment, the direction-specific upper-limit number M02 for tunnel connections that are based on device-triggered communication requests is set to a greater value than the direction-specific upper-limit number M01 for tunnel connections that are based on application-triggered communication requests. Accordingly, the number Q0 of existing tunnel connections based on device-triggered communication requests is less likely to exceed the updated direction-specific upper-limit number M02 that corresponds to device-triggered communication requests, and the procedure is less likely to proceed from step S78 to step S79. That is, the time interval of HTTP requests for tunnel connection based on device-triggered communication requests (i.e., “upward” communication requests) is less likely to be reduced, which makes it relatively easier to secure the aforementioned immediacy (quick response).

### 3. Variations

While the above has been a description of embodiments of the present invention, the present invention is not limited to the content described above.

For example, while in the above-described embodiments, the same application-specific upper-limit number M is used for each application, the present invention is not limited to this example. Different application-specific upper-limit numbers M may be used for each application.

While in the above-described embodiments, the application-specific upper-limit number M is determined on the basis of predetermined values stored in the upper-limit number setting table 210, the present invention is not limited to this example. The application-specific upper-limit number M may be determined on the basis of other information (e.g., connection history).

More specifically, the application-specific upper-limit number M may be determined on the basis of the history of connection between a gateway 30 and each application 80. More specifically, when a gateway 30 currently has individual connections with multiple applications (e.g., two applications 80a and 80b), the application-specific upper-limit number for each application may be determined on the basis of information about past connection (connection history) between the multiple applications and the gateway.

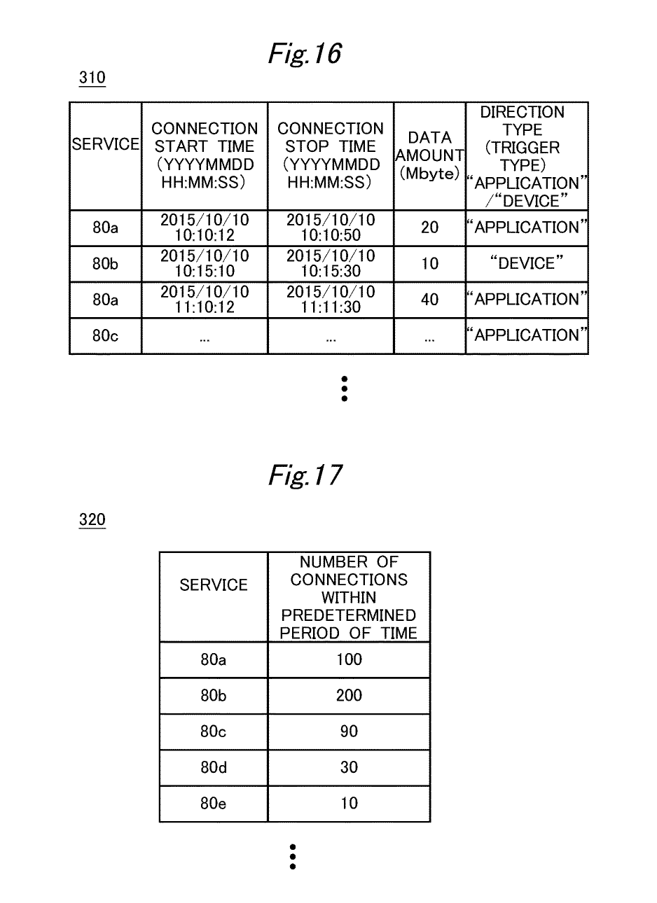

FIG. 16 illustrates information (connection history information) 310 about the connection history (communication history) of tunnel connections between a gateway 30 and each application 80.

As illustrated in FIG. 16, the connection history of tunnel connections with the gateway 30 include various types of information such as “communication destination application (service),” “connection start time,” “connection stop time,” and “data traffic rate per connection.”

The gateway 30 stores this information (connection history information) 310 about the connection history in its storage. Note that the connection history information 310 is updated whenever necessary.

The gateway 30 acquires various types of information (e.g., “number of connections per unit of time” and “data traffic per unit of time”) for each application (see FIG. 17) when determining the application-specific upper-limit number M in, for example, step S56 (see FIG. 10) described above. It can also be said that these pieces of information (e.g., “number of connections per unit of time” and “data traffic per unit of time”) are index values that indicate the amount of load of communication in the past connection between the gateway 30 and each application 80. These pieces of information are also based on the connection history information and acquired as the result of summarization of the connection history information.

FIG. 17 illustrates a summarization result 320 obtained by summarizing the connection history information 310. In FIG. 17, the number of tunnel connections within a predetermined period of time (unit of time), e.g., a day, is tabulated for each application.

The gateway 30 determines the application-specific upper-limit number M for each application on the basis of, for example, the “number of connections per unit of time.”

In the above-described embodiment, when the gateway already has a tunnel connection with two applications, the same value (i.e., “15”) is always allocated to each of the two applications as the application-specific upper-limit number M (same value). In contrast, according to this variation, different values may be allocated to the two applications as the application-specific upper-limit numbers M. In particular, the application-specific upper-limit number M for each application is set to reflect the connection history (past operating state) of the application.

To be more specific, a relatively small value is allocated as the application-specific upper-limit number M to an application (service) having a small number of connections per unit of time. On the contrary, a relatively large value is allocated as the application-specific upper-limit number M to an application (service) having a large number of connections per unit of time. In other words, the application-specific upper-limit number M for each application is determined in consideration of the past load of communication on the application.

For example, the aforementioned maximum number X of connections (e.g., “30”), which is based on the throughput of the gateway 30, may be divided into the two applications in accordance with the ratio of the number of connections per unit of time between the two applications. To be more specific, when the number of connections per unit of time for one application 80a is “100” and the number of connections per unit of time for the other application 80b is “200,” the application-specific upper-limit number M for the application 80a may be set to “10” and the application-specific upper-limit number M for the application 80b may be set to “20.”

Alternatively, the application-specific upper-limit number M for each application may be determined by dividing the maximum number X in accordance with the ratio of data traffic per unit of time between the two applications. For example, when the data traffic for one application 80a is two times the data traffic for the other application 80b, the application-specific upper-limit number M for the application 80a may be set to “20” and the application-specific upper-limit number M for the application 80b may be set to “10.”

In this case, information such as the frequency of use of each application is acquired on the basis of the actual connection history of the application, and the application-specific upper-limit number M is appropriately set in accordance with this information (e.g., the frequency of use). Thus, the resource of the gateway 30 will be appropriately divided into multiple applications. To be more specific, a relatively small value is allocated as the application-specific upper-limit number M to a relatively low-use application in actual practice (e.g., a counter-information gathering service or a device-information acquiring service (status polling service)). On the other hand, a relatively large value is allocated as the application-specific upper-limit number M to a relatively high-use application in actual practice (e.g., a cloud printing service). Accordingly, the number of connections is less likely to reach the application-specific upper-limit number M.

Note that the frequency of use of each application often varies, for example, from customer corporation to customer corporation. Thus, the variation as described above is extremely preferable because the actual frequency of use by each customer corporation is reflected.

A similar idea may also be applied to cases such as dividing the application-specific upper-limit number M into two type-specific upper-limit numbers M01 and M02. More specifically, the number of tunnel connections within a predetermined period of time (unit of time) may be summarized for each application on the basis of the connection history information 310 (see FIG. 17), and the number of connections per unit of time for each application may be divided and summarized by direction (by type). Then, the direction-specific ratio (direction-specific ratio (type-specific ratio) of the number of connections per unit of time) may be calculated for each application on the basis of the result of the summarization. For example, when the ratio between the number of tunnel connections based on “downward” communication requests per unit of time and the number of tunnel connections based on “upward” communication requests per unit of time is 2:3 for an application, the ratio between the direction-specific upper-limit numbers M01 and M02 may be set to “2:3.” To be more specific, if a value of 15 is allocated to the application 80 as the application-specific upper-limit number M, the direction-specific upper-limit number M01 may be set to “6” and the direction-specific upper-limit number M02 may be set to “9”.

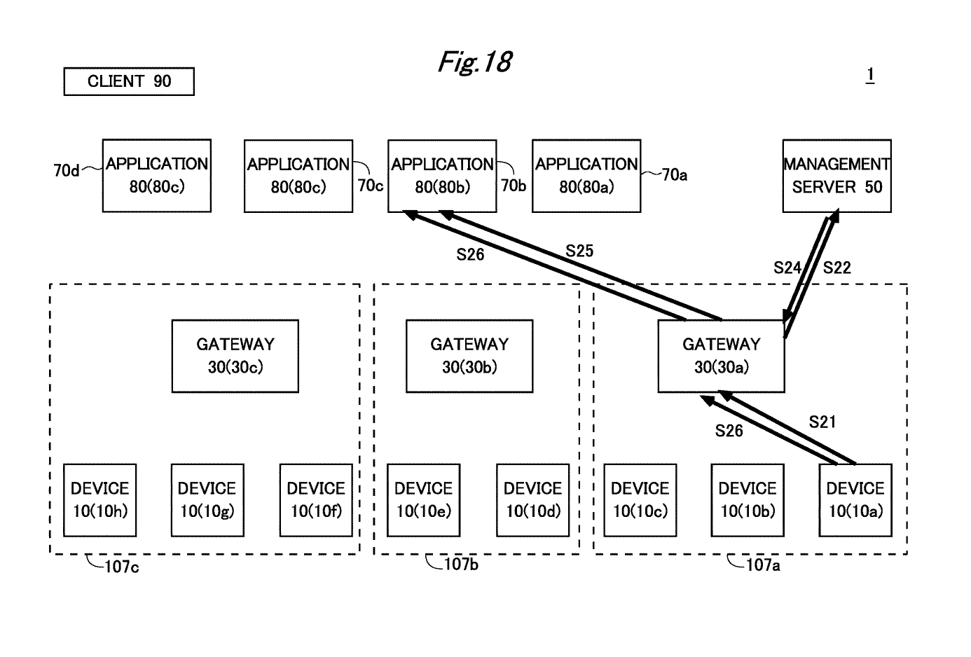

While, in the above-described embodiments, communication requests from the devices 10 (i.e., tunnel connection requests from the devices 10) are transmitted to the gateway 30 by bypassing the management server 50 (i.e., transmitted directly) (see FIG. 8), the present invention is not limited to this example. For example, a tunnel connection request from a device 10 may be transmitted from the device 10 via the management server 50 to a gateway 30 as illustrated in FIG. 18. To be more specific, the communication request from the device 10 (step S21) may be transmitted via the gateway 30 to the management server 50 (step S22), and a tunnel connection request may be transmitted from the management server 50 to the gateway 30 (step S24). Then, the gateway 30 may transmit a tunnel-connection establishment request to an application 80 on the basis of the communication request received from the device 10 and the connection request received from the management server 50.

While the system 1 according to the above-described embodiments includes multiple devices 10, the present invention is not limited to this example, and the system 1 may include only a single device 10.

While the system 1 according to the above-described embodiments includes multiple cloud servers 70, the present invention is not limited to this example, and the system 1 may include only a single cloud server 70.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. A communication system comprising:
at least one device provided inside a firewall;
at least one cloud server provided outside the firewall; and
a communication relay device configured to relay communication between the at least one device and at least one application that is executed by the at least one cloud server,
wherein the communication relay device includes:
a communication control unit configured to receive a connection request that is based on a communication request received from one of the at least one device or one of the at least one application and that is a request to establish an individual connection between the communication relay device and one application among the at least one application; and
a determination unit configured to determine an application-specific upper-limit number on the basis of circumstances of establishment of individual connection between the communication relay device and the at least one application, the application-specific upper-limit number being an upper-limit number for each application and being an upper-limit number of individual connections that can be established between the communication relay device and the at least one application, and
the communication control unit is configured to:
establish a new individual connection with the one application in accordance with the connection request, on condition that a total number of individual connections currently established between the communication relay device and the one application is less than the application-specific upper-limit number for the one application; and
in the presence of a high-load application, increase a time interval of requests for communication between the high-load application and the communication relay device, the high-load application being an application whose total number of individual connections currently established with the communication relay device exceeds the application-specific upper-limit number.

2. The communication system according to claim 1, wherein
the determination unit is configured to reduce the application-specific upper-limit number when a connection request, which is a request to establish an individual connection with an application other than an application that has already established an individual connection with the communication relay device, has been received, and
the communication control unit is configured to, if the reduction of the application-specific upper-limit number causes the high-load application to arise, increase a time interval of requests for communication between the high-load application and the communication relay device.

3. The communication system according to claim 1, wherein
the determination unit is configured to determine the application-specific upper-limit number on the basis of a maximum number of individual connections that can be established between the communication relay device and the at least one application, and a current number of applications that currently have an individual connection with the communication relay device.

4. The communication system according to claim 1, wherein
the determination unit is configured to determine the application-specific upper-limit number by equally dividing a maximum number of individual connections that can be established between the communication relay device and the at least one application into a plurality of applications that currently have an individual connection with the communication relay device.

5. The communication system according to claim 1, wherein
the determination unit is configured to determine the application-specific upper-limit number for each of a plurality of applications that currently have an individual connection with the communication relay device, on the basis of information about a connection history of the plurality of applications and the communication relay device.

6. The communication system according to claim 5, wherein
the determination unit is configured to determine the application-specific upper-limit number for each application by dividing a maximum number of individual connections that can be established with the communication relay device into the plurality of applications on the basis of a ratio of index values that indicate the amount of load of communication in past connection between the plurality of applications and the communication relay device.

7. The communication system according to claim 1, wherein
the communication control unit is configured to determine whether the connection request is based on a first type of communication request or a second type of communication request,
the first type of communication request being a communication request that is issued in a direction from the at least one application to the at least one device, and
the second type of communication request being a communication request that is issued in a direction from the at least one device to the at least one application,
the determination unit is configured to additionally determine a type-specific upper-limit number by dividing the application-specific upper-limit number into the first type of communication request and the second type of communication request, and
the communication control unit is configured to establish a new individual connection with the one application in response to the connection request, on condition that among a total number of individual connections currently established between the communication relay device and the one application, the number of individual connections that are based on a specific type of communication request that is the same type as a communication request type of the connection request is less than the type-specific upper-limit number for the one application and for the specific type of communication request.

8. The communication system according to claim 7, wherein
the communication control unit is configured to, in the presence of a type-specific high-load application that is an application whose total number of individual connections that are based on a predetermined type of communication request among the individual connections currently established with the communication relay device exceeds the type-specific upper-limit number for the predetermined type of communication request, increase a time interval of requests for communication that is established between the type-specific high-load application and the communication relay device and that corresponds to the predetermined type of communication request.

9. The communication system according to claim 7, wherein
the determination unit is configured to determine that the type-specific upper-limit number for the second type of communication request be a greater value than the type-specific upper-limit number for the first type of communication request.

10. The communication system according to claim 7, wherein
the communication control unit is configured to determine, on the basis of a communication protocol used for the connection request, whether the connection request is the first type of communication request or the second type of communication request.

11. The communication system according to claim 1, further comprising:
a management server configured to manage communication that is established via the communication relay device between the at least one device and the at least one application,
the management server including:
a unit configured to acquire standby-state information about a current standby state of individual connections within the communication relay device; and
a unit configured to, when a first type of communication request is received from one of the at least one application, determine, on the basis of the standby-state information, whether to immediately transmit a connection request that is based on the first type of communication request to the communication relay device or to put the transmission of the connection request on hold, the first type of communication request being a communication request that is issued in a direction from the at least one application to the at least one device.

12. A communication relay device for relaying communication between at least one device provided inside a firewall and at least one application that is executed by at least one cloud server provided outside the firewall, the communication relay device comprising:
a communication control unit configured to receive a connection request that is based on a communication request received from one of the at least one device or one of the at least one application and that is a request to establish an individual connection between the communication relay device and one application among the at least one application; and
a determination unit configured to determine an application-specific upper-limit number on the basis of circumstances of establishment of individual connection between the communication relay device and the at least one application, the application-specific upper-limit number being an upper-limit number for each application and being an upper-limit number of individual connections that can be established between the communication relay device and the at least one application,
wherein the communication control unit is configured to:
establish a new individual connection with the one application in response to the connection request, on condition that a total number of individual connections currently established between the communication relay device and the one application is less than the application-specific upper-limit number for the one application, and
in the presence of a high-load application, increase a time interval of requests for communication between the high-load application and the communication relay device, the high-load application being an application whose total number of individual connections currently established with the communication relay device exceeds the application-specific upper-limit number.

13. The communication relay device according to claim 12, wherein
the determination unit is configured to reduce the application-specific upper-limit number when a connection request, which is a request to establish an individual connection with an application other than an application that has already established an individual connection with the communication relay device, has been received, and
the communication control unit is configured to, when the reduction of the application-specific upper-limit number causes the high-load application to arise, increase a time interval of requests for communication between the high-load application and the communication relay device.

14. The communication relay device according to claim 12, wherein
the determination unit is configured to determine the application-specific upper-limit number on the basis of a maximum number of individual connections that can be established between the communication relay device and the at least one application, and a current number of applications that currently have an individual connection with the communication relay device.

15. The communication relay device according to claim 12, wherein
the determination unit is configured to determine the application-specific upper-limit number by dividing a maximum number of individual connections that can be established between the communication relay device and the at least one application into a plurality of applications that currently have an individual connection with the communication relay device.

16. The communication relay device according to claim 12, wherein
the determination unit is configured to determine the application-specific upper-limit number for each of a plurality of applications that currently have an individual connection with the communication relay device, on the basis of information about a connection history of the plurality of applications and the communication relay device.

17. The communication relay device according to claim 16, wherein
the determination unit is configured to determine the application-specific upper-limit number for each application by dividing a maximum number of individual connections that can be established with the communication relay device into the plurality of applications on the basis of a ratio of index values that indicate the amount of load of communication in past connection between the plurality of applications and the communication relay device.

18. The communication relay device according to claim 12, wherein
the communication control unit is configured to determine whether the connection request is based on a first type of communication request or a second type of communication request,
the first type of communication request being a communication request that is issued in a direction from the at least one application to the at least one device, and
the second type of communication request being a communication request that is issued in a direction from the at least one device to the at least one application,
the determination unit is configured to additionally determine a type-specific upper-limit number by dividing the application-specific upper-limit number into the first type of communication request and the second type of communication request, and
the communication control unit is configured to establish a new individual connection with the one application in response to the connection request, on condition that among a total number of individual connections currently established between the communication relay device and the one application, the number of individual connections that are based on a specific type of communication request that is the same type as a communication request type of the connection request is less than the type-specific upper-limit number for the one application and for the specific type of communication request.

19. The communication relay device according to claim 18, wherein
the communication control unit is configured to, in the presence of a type-specific high-load application that is an application whose total number of individual connections that are based on a predetermined type of communication request among the individual connections currently established with the communication relay device exceeds the type-specific upper-limit number for the predetermined type of communication request, increase a time interval of requests for communication connection that is established between the type-specific high-load application and the communication relay device and that corresponds to the predetermined type of communication request.

20. The communication relay device according to claim 18, wherein
the determination unit is configured to determine that the type-specific upper-limit number for the second type of communication request be a greater value than the type-specific upper-limit number for the first type of communication request.

21. The communication relay device according to claim 18, wherein
the communication control unit is configured to determine, on the basis of a communication protocol used for the connection request, whether the connection request is based on the first type of communication request or the second type of communication request.

22. A non-transitory computer-readable recording medium having stored therein a program that causes a computer that is built into a communication relay device for relaying communication between at least one device provided inside a firewall and at least one application that is executed by at least one cloud server provided outside the firewall, to execute the steps of:
a) receiving a connection request that is based on a communication request received from one of the at least one device or one of the at least one application and that is a request to establish an individual connection between the communication relay device and one application among the at least one application;
b) determining an application-specific upper-limit number on the basis of circumstances of establishment of individual connection between the communication relay device and the at least one application, the application-specific upper-limit number being an upper-limit number for each application and being an upper-limit number of individual connections that can be established between the communication relay device and the at least one application;
c) establishing a new individual connection with the one application in response to the connection request, on condition that a total number of individual connections currently established between the communication relay device and the one application is less than the application-specific upper-limit number for the one application; and
d) in the presence of a high-load application, increasing a time interval of requests for communication between the high-load application and the communication relay device, the high-load application being an application whose total number of individual connections currently established with the communication relay device exceeds the application-specific upper-limit number.
